(19) United States
(12) Patent Application Publication
(10) Pub. No.: US 2025/0229854 A1
(43) Pub. Date: Jul. 17, 2025

(54) DRIVE SPROCKET MEMBER FOR AN ENDLESS TRACK OF A TRACKED VEHICLE

(71) Applicant: BAE Systems Hägglunds Aktiebolag, Örnsköldsvik (SE)

(72) Inventor: Håkan STRÖMBERG, Kalix (SE)

(73) Assignee: BAE Systems Hägglunds Aktiebolag, Örnsköldsvik (SE)

(21) Appl. No.: 18/855,961

(22) PCT Filed: Apr. 6, 2023
(86) PCT No.: PCT/SE2023/050320

§ 371 Date: Oct. 10, 2024

(30) Foreign Application Priority Data
Apr. 12, 2022 (SE) 2250456-7

(51) Int. Cl. B62D 55/088; B62D 55/125

(52) U.S. Cl. CPC B62D 55/0885; B62D 55/125

(57) ABSTRACT

The present invention relates to a drive sprocket member for a drive wheel member of a tracked vehicle. The drive wheel member is rotatable about a centre axis for rotating an endless track. Said drive sprocket member comprises a set of tooth members arranged around the circumference of said drive sprocket member, and a ring-shaped support member for said tooth members. Said tooth members are, in an operation position, configured to project from the ring-shaped support member in a main direction essentially parallel to the axial direction of said centre axis. Said tooth members are arranged in connection to said ring-shaped support member and shaped so as to provide resilient properties in the radial direction such that, if a tooth member is subjected to a radial force exceeding a certain threshold, said tooth member is configured to deform relative to its operation position.

### CROSS-REFERENCE TO RELATED APPLICATIONS

This application is a U.S. national stage application under 35 U.S.C. § 371 of International Application No. PCT/SE2023/050320, filed Apr. 6, 2023, which claims the priority of SE Application No. 2250456-7, filed Apr. 12, 2022. The entire contents of each priority application is incorporated herein by reference.

### FIELD OF THE DISCLOSURE

The present invention relates to a drive sprocket member for a drive wheel member for an endless track of a tracked vehicle. The present invention also relates to a drive wheel member having such a drive sprocket member. The present invention also relates to a tracked vehicle comprising drive wheel members having such drive sprocket members.

### BACKGROUND OF THE DISCLOSURE

Tracked vehicles may be equipped with opposite track assemblies. Each track assembly comprises an endless track arranged to run over a set of wheels comprising a drive wheel member, a tension wheel and a set of road wheels there between.

A drive wheel member may be equipped with a hub member and a transversal inner drive sprocket member and a transversal outer drive sprocket member connected to the respective side of the hub member.

Such tracked vehicles, e.g. combat vehicles, are intended to be driven in rough terrain. A problem during drive in rough terrain with such vehicles, in particular in connection to reversing and turning, is that ingestion of undesired material such as gravel and stones into the respective track assembly and in between wheels, in particular drive wheel members, and the endless track may occur, which in turn cause damages to the tracked vehicle, comprising damages to drive wheel member and tracks, and may in some cases result in the endless track being torn apart.

Further, wear on drive wheel members may be relatively large. When using endless tracks of rubber, exchange of drive wheel members needs to be performed in a workstation, where each drive sprocket member of the drive wheel member needs to be removed.

There is a need for providing a drive sprocket member for a drive wheel member for an endless track, which further facilitates reducing such damages and facilitates maintenance.

### OBJECTS OF THE DISCLOSURE

An object of the present invention is to provide a drive sprocket member for a drive wheel member for an endless track of a tracked vehicle, which facilitates reducing/preventing damages to endless tracks and drive wheel member.

A further object of the present invention is to provide a drive sprocket member for a drive wheel member for an endless track of a tracked vehicle, which facilitates maintenance of the drive wheel member.

A further object of the present invention is to provide a drive wheel member comprising such a drive sprocket member.

A further object of the present invention is to provide a tracked vehicle comprising such a drive sprocket member.

### SUMMARY OF THE DISCLOSURE

These and other objects, apparent from the following description, are achieved by a drive sprocket member, a drive wheel member, and a tracked vehicle, as set out in the appended independent claims. Preferred embodiments of the drive sprocket member and drive wheel member are defined in appended dependent claims.

Specifically, an object of the invention is achieved by a drive sprocket member for a drive wheel member for an endless track of a tracked vehicle. The drive wheel member is rotatable about a centre axis for rotating said endless track. Said drive wheel member comprises said drive sprocket member. Said drive sprocket member comprises a set of tooth members arranged around the circumference of said drive sprocket member, and a ring-shaped support member for said tooth members. Said tooth members are configured to project from the ring-shaped support member in a main direction essentially parallel to the axial direction of said centre axis so that said tooth members are in an operation position for engaging with said endless track for facilitating said rotation of said endless track. Said tooth members are arranged in connection to said ring-shaped support member and shaped so as to provide resilient properties in the radial direction such that, if a tooth member of said set of tooth members is subjected to a radial force, in the direction towards said centre axis, exceeding a certain threshold, said tooth member is configured to deform relative to its operation position. Thus, said tooth members are hereby configured such that, if a tooth member is subjected to said radial force exceeding said certain threshold, deformation of said tooth member relative to its operation position is facilitated.

According to an aspect of the present disclosure, said tooth members are shaped, arranged and configured so as to facilitate said deformation, when subjected to such a radial force. According to an aspect of the present disclosure, said tooth members are shaped and configured so as to facilitate controlled deformation. According to an aspect of the present disclosure, said tooth members are shaped and configured so as to facilitate controlled deformation in the direction towards the centre axis when subjected to a radial force exceeding a predetermined threshold. According to an aspect of the present disclosure, said tooth members have an elongated configuration configured to project from said ring-shaped support member in said main direction essentially parallel to the axial direction of said centre axis.

According to an aspect of the present disclosure, said tooth members are arranged in connection to said ring-shaped support member and configured to project from said ring-shaped support member in said main direction essentially parallel to the axial direction of said centre axis, wherein said tooth members have an axial length, a radial thickness and a material with a modulus of elasticity, so as to provide said resilient properties. According to an aspect of the present disclosure, said tooth members have a shape comprising radial, axial and tangential extension and configuration, and a material with a modulus of elasticity, so as to provide said resilient properties.

Said tooth members are configured to project from the ring-shaped support member, in connection to a radial outer side of said ring-shaped support member, in a main direction essentially parallel to the axial direction of said centre axis, ending at a predetermined distance away from said ring-shaped support member. According to an aspect of the present disclosure, said tooth members have an end side axially furthest away from said ring-shaped support member, wherein the axial length, i.e. the distance of the main direction of extension, of the respective tooth member corresponds to the distance from the ring-shaped support member where the tooth member projects to the end side of said tooth member.

The length of the tooth member may be any suitable length for facilitating said resilient properties so that deformation of said tooth member in the direction towards said centre axis is facilitated when said tooth member is subjected to a radial force exceeding a predetermined threshold. According to an aspect of the present disclosure, the length of the tooth member is in the range of 30% to 100% of the radial distance between the main direction of extension of a tooth member and the centre axis, according to an aspect in the range of 50% to 80% of the radial distance between the main direction of extension and the centre axis.

The average axial thickness of the ring-shaped support member may be any suitable thickness for facilitating arranging said tooth member in connection to said ring-shaped support member, e.g. as an integrated portion of or an attachment to said ring-shaped support member. According to an aspect of the present disclosure, said ring-shaped support member has an average axial thickness, i.e. a thickness in the direction essentially parallel to the axial direction of said centre axis. According to an aspect of the present disclosure, said average axial thickness of said ring-shaped support member is in the range of 5% to 20%, according to an aspect about 7% to 15%, of the length, i.e. axial extension, of a tooth member.

The average radial thickness of the tooth member may be any suitable thickness for facilitating said resilient properties so that deformation of said tooth member in the direction towards said centre axis is facilitated when said tooth member is subjected to a radial force exceeding a predetermined threshold. According to an aspect of the present disclosure, said tooth members have an average radial thickness, i.e. thickness in the radial direction when arranged around the circumference of said drive sprocket member, is in the range of 5% to 15%, according to an aspect about 7% to 12% of the length of a tooth member. According to an aspect of the present disclosure, the average radial thickness of the respective tooth member essentially corresponds to the axial thickness of said ring-shaped support member. According to an aspect of the present disclosure, said tooth members have variable radial thickness, wherein said radial thickness is configured to change linearly and/or non-linearly along the main extension of said tooth member so as to provide desired resilient properties and so as to provide an even material tension.

According to an aspect of the drive sprocket member, said tooth member has a tapering configuration from said ring-shaped support member towards the end of said tooth member, so as to facilitate said resilient properties in the radial direction, such that if said tooth member, i.e. an engagement portion of said tooth member, is subjected to a radial force exceeding a certain threshold, deformation of said tooth member is facilitated.

According to an aspect of the drive sprocket member, said tooth member has a tapering configuration from said ring-shaped support member towards the end of said tooth member, said tapering configuration having a curvature adapted so as to obtain desired resilient properties and material tensions, such that if said tooth member, e.g. an engagement portion of said tooth member, is subjected to a radial force exceeding a certain threshold, deformation of said tooth member is facilitated. According to an aspect of the drive sprocket member, said curvature of said tapering configuration of said tooth member, has a linear portion and/or an exponential portion and/or a parabolic portion, e.g. a parabolic portion according to the elastic curvature of a beam.

According to an aspect of the drive sprocket member, said tooth member has a curvature configuration from said ring-shaped support member towards the end of said tooth member adapted so as to obtain desired resilient properties and material tensions, such that if said tooth member is subjected to a radial force exceeding a certain threshold, deformation of said tooth member is facilitated. According to an aspect of the drive sprocket member said curvature configuration of said tooth member, has a linear portion and/or an exponential portion and/or a parabolic portion.

According to an aspect of the drive sprocket member, said tooth member has a tapering configuration from said ring shaped support member in its main direction so as to facilitate high stiffness of the tooth member in the tangential direction of said ring shaped support member and resilient properties for deformation of said tooth member in the radial direction.

According to an aspect of the drive sprocket member, said tooth members comprises a material having a predetermined modulus of elasticity, wherein said shape of said tooth members, comprising radial, axial and tangential extension and configuration, in combination with said predetermined modulus of elasticity of the material of said tooth members, provides said resilient properties, so that, if a tooth member is subjected to said radial force, deformation of said tooth member in the direction towards said centre axis is facilitated.

According to an aspect of the drive sprocket member, the respective tooth member has a varying shape along its main extension, said varying shape comprising portions tapering from said ring-shaped support member in the tangential direction of said ring-shaped support member and resilient properties for facilitating deformation of a tooth member in the radial direction if subjected to said radial force.

Said tooth members, when thus deforming, are configured to be retained in connection to said ring-shaped support member. According to an aspect of the present disclosure, said deformation of a tooth member caused by a certain radial force acting on that tooth member may depend on the modulus of elasticity of the material of said ring-shaped drive sprocket member, in particular the modulus of elasticity of the material of said tooth members, and the shape of said drive sprocket member including the shape of said tooth members of said drive sprocket member, comprising radial, axial and tangential extension and configuration of said tooth members and their arrangement relative to said ring-shaped support member.

The material of said ring-shaped sprocket member/tooth members of said sprocket member may be any suitable material facilitating the above-mentioned properties, comprising resilient properties. The material may, for example, be any of: conventional metals comprising steel; super elastic alloys; metal matrix composites; amorphous metals; polymer based composites; Shape Memory Alloys (SMA) metals; Carbon Nano Tubes (CNT) or other materials based on nanotechnology.

The manufacturing method of said ring-shaped sprocket member/tooth members of said sprocket member may be any suitable manufacturing method facilitating providing the above-mentioned properties. Manufacturing methods may, for example, be any of: machining; casting; lamination; sintering; injection moulding; hot isostatic pressing; conventional forging; flow forming; additive manufacturing.

According to an aspect of the present disclosure, said drive wheel member comprises a hub member. According to an aspect of the present disclosure, said hub member is provided for facilitating assembly of the drive wheel member to the tracked vehicle and for facilitating operation of the drive wheel member. According to an aspect of the present disclosure, said drive sprocket member is configured to be attached to said hub member.

By providing such a drive sprocket member with tooth members thus arranged and shaped so as to provide such resilient properties that they, when subjected to a certain radial force are configured to deform relative to its operation position, damages to the endless track and tooth members due to ingestion of undesired material/objects such as gravel and stones in between drive wheel member and endless track may be efficiently reduced, in that such material/objects will escape due to the deformation of tooth member(s). By thus providing tooth members thus arranged and shaped so that they provide resilient properties in the radial direction when subjected to a radial force exceeding a certain threshold so that they deform while retained, the risk of damages to the endless track comprising risk of endless track being torn apart may be efficiently reduced. By providing a ring-shaped drive sprocket member having such resilient properties a drive sprocket member being resistant to external forces is facilitated. By providing a ring-shaped drive sprocket member having such resilient properties, an energy absorbing drive sprocket member may be provided for any kind of operation situation of the tracked vehicle.

According to an aspect of the drive sprocket member, said tooth members are arranged in connection to said ring-shaped support member and shaped so as to provide resilient properties in the radial direction such that, if a tooth member of said set of tooth members is subjected to a radial force, in the direction towards said centre axis, exceeding a first threshold and up to second threshold, said tooth member is configured to elastically deform relative to its operation position so that, when said tooth member is no longer subjected to said radial force, said tooth member is configured to return to its operation position. By thus providing tooth members thus arranged and shaped so that they, when subjected to a radial force exceeding a certain threshold elastically deform and return to their operation position when no longer subjected to such a force, damages to the endless track and tooth members due to ingestion of undesired material/objects such as gravel and stones in between drive wheel member and endless track may be efficiently reduced, in that such material/objects will escape when tooth member are elastically deformed. According to an aspect of the present disclosure, a thus arranged and configured tooth member, subjected to such a radial force between said first threshold and up to said second threshold, may be configured to elastically deform so that said tooth member, when being subjected to said radial force, projects from the ring-shaped support member in a main direction with an angle relative to and towards the axial direction of said centre axis up to a certain predetermined main direction, which depends on e.g. modulus of elasticity and shape, configuration and arrangement of the tooth member.

According to an aspect of the drive sprocket member, said tooth members are arranged in connection to said ring-shaped support member and shaped so as to provide resilient properties in the radial direction such that, if a tooth member of said set of tooth members is subjected to a radial force, in the direction towards said centre axis, exceeding a second threshold, said tooth member is configured to plastically deform relative to its operation position so that, when said tooth member is no longer subjected to said radial force, said tooth member is configured to essentially remain in its deformed position. According to an aspect of the present disclosure, said second threshold corresponds to the threshold up to which said tooth member is subjected to an elastic deformation. By thus providing tooth members thus arranged and shaped so that they, when subjected to a radial force exceeding a certain threshold, plastically deform and remain at their deformed position when no longer subjected to such a force, damages to the endless track and tooth members due to ingestion of undesired material/objects such as gravel and stones in between drive wheel member and endless track may be efficiently reduced, in that such material/objects will escape when tooth member are plastically deformed, and in that such deformed tooth members are retained, and may, by proper tools, be returned to their operation position, so that the drive sprocket member is fully repaired and ready to be used again. Hereby said drive sprocket member may be subjected to larger forces due to e.g. ingestion of one or more relatively larger objects between radial outer side of tooth member and radial inner side of said endless track without causing any damages to the endless track and any non-repairable damages to tooth members. According to an aspect of the present disclosure, a thus arranged and configured tooth member, subjected to such a radial force exceeding said second threshold, may be configured to plastically deform so that said tooth member projects from the ring-shaped support member in a main direction with an angle relative to and towards the axial direction of said centre axis in a range from an angle greater than where elastic deformation occurs up to a predetermined angle, e.g. about 90 degrees. Said tooth member is retained in connection to said ring-shaped support member.

According to an aspect of the present disclosure, said drive sprocket member including said tooth members of said drive sprocket member has a shape, comprising radial, axial and tangential extension and configuration, and a material with a modulus of elasticity, so that when a tooth member is subjected to an inwardly directed radial force within a range up to a predetermined threshold value, said tooth member is configured to elastically deform relative to its operation position so that, when said tooth member is no longer subjected to such a radial force, said tooth member is configured to return to its operation position, and when said tooth member is subjected to an inwardly directed radial force exceeding said predetermined threshold value, said tooth member is configured to plastically deform relative to its operation position so that, when said tooth member is no longer subjected to said radial force, said tooth member is configured to essentially remain in its deformed position.

Said first threshold and second threshold of such a radial force acting on a tooth member may be thus be any suitable radial force and may further depend on size comprising weight of tracked vehicle. For a tracked vehicle being a combat vehicle, said second threshold value may be in the range of about 100 kN, but may be lower or higher. Radial forces may be within any suitable range such as e.g. 0-200 kN. According to an aspect of the present disclosure, said radial force up to which said tooth member would elastically deform, may depend on said arrangement and configuration of said tooth member comprising radial, axial and tangential extension, but also the modulus of elasticity of said tooth member. According to an aspect of the present disclosure, for a tracked vehicle such as a combat vehicle, said radial force up to which said tooth member would elastically deform may be in the range of 40 kN to 140 kN, according to an aspect in the range of 70 kN to 120 kN.

According to an aspect of the present disclosure, a thus arranged and configured tooth member, subjected to such a radial force up to which said tooth member is configured to elastically deform, may be configured to elastically deform so that said tooth member projects from the ring-shaped support member in a main direction with an angle relative to and towards the centre axis, i.e. axial direction of said centre axis, in the range of 10 degrees to 50 degrees, according to an aspect in the range of 15 degrees to 35 degrees. According to an aspect of the present disclosure, a thus arranged and configured tooth member, subjected to such a radial force exceeding said radial force up to which said tooth member is configured to elastically deform, is configured to plastically deform so that said tooth member projects from the ring-shaped support member in a main direction with an angle relative to and towards the axial direction of said centre axis exceeding said angle up to which said tooth member is configured to elastically deform.

According to an aspect of the present disclosure, a thus arranged and configured tooth member, subjected to a radial force exceeding a certain threshold, is configured to deform from said operation position to a deformed position in a direction towards said centre axis, said deformation, i.e. movement of the tooth member, being configured to occur within a plane essentially orthogonal to the tangential direction of said ring-shaped support member, said plane, according to an aspect, having an essentially sector-like configuration extending in the axial and radial direction. According to an aspect of the present disclosure, a thus arranged and configured tooth member, subjected to a radial force exceeding a certain threshold, may be configured to deform in a curved manner so that said tooth member, in a deformed position, projects from the ring-shaped support member in a direction with an extension having a curved shaped. Such a curved extension from said ring-shaped support member of a tooth member having been subjected to a radial force exceeding a certain threshold, has, according to an aspect, a main direction of extension from said ring-shaped support member with an angle relative to and towards the centre axis, i.e. axial direction of said centre axis.

According to an aspect of the drive sprocket member, said tooth members are arranged in connection to said ring-shaped support member and shaped so as to provide resilient properties in the radial direction such that, if a tooth member of said set of tooth members is subjected to a radial force, in the direction towards said centre axis, so that said tooth member deforms relative to its operation position, said deformation will correspond to said tooth member projecting from the ring-shaped support member in a main direction with an angle relative to and towards the axial direction of said centre axis. Said angle depends among others of how high the radial force is. According to an aspect of the present disclosure, a thus arranged and configured tooth member, subjected to a radial force, may be configured to deform so that said tooth member projects from the ring-shaped support member in a main direction with an angle relative to and towards the axial direction of said centre axis up to at least 20 degrees, according to an aspect up to at least 30 degrees, according to an aspect up to at least 40 degrees, according to an aspect up to at least 50 degrees, according to an aspect up to at least 60 degrees, according to an aspect up to at least 70 degrees, according to an aspect up to at least 80 degrees. Said angle up to which said tooth member is allowed to deform may depend on said arrangement and configuration of said tooth member, but also the modulus of elasticity of said tooth member, and where applicable the modulus of elasticity of said ring-shaped support member in connection to said tooth member.

According to an aspect of the drive sprocket member, said tooth member has a radial outer side which, when said tooth member is in the operation position, in connection to engagement with said endless track is configured to face a radial inner side of said endless track, wherein said tooth member is configured such that if one or more objects, during operation of said tracked vehicle is introduced between said radial inner side of said endless track and said radial outer side of said tooth member so that said tooth member is subjected to a radial force, in the direction towards said centre axis, exceeding a certain threshold, said tooth member is configured to deform relative to its operation position so that said one or more objects are allowed to escape. Hereby the damages to the endless track and tooth members due to ingestion of undesired objects such as gravel and stones in between drive wheel member and endless track may be efficiently reduced.

According to an aspect of the present disclosure, said tooth member is configured and arranged in connection to said ring-shaped support member and shaped so as to provide resilient properties in the radial direction such that if one or more objects, during operation of said tracked vehicle is introduced between said radial inner side of said endless track and said radial outer side of said tooth member so that said tooth member is subjected to a radial force, in the direction towards said centre axis, exceeding a certain threshold, said tooth member is configured to deform relative to its operation position so that said one or more objects are subjected to an axial force in an outward transversal direction so that said one or more objects escape from the track assembly and hence tracked vehicle.

According to an aspect of the present disclosure, said tooth member is configured and arranged in connection to said ring-shaped support member and shaped so as to provide resilient properties in the radial direction such that if one or more objects, during operation of said tracked vehicle is introduced between said radial inner side of said endless track and said radial outer side of said tooth member so that said tooth member is subjected to a radial force, in the direction towards said centre axis, exceeding a certain threshold, said tooth member is configured to deform relative to its operation position so that said tooth member is projecting from the ring-shaped support member in a main direction with an angle relative to and towards the axial direction of said centre axis, so that said one or more objects, due to the shape and resilient properties and the angled deformation of said tooth member relative to the radial inner side of said endless track, are subjected to an axial force in an outward transversal direction so that said one or more objects are configured to escape from the track assembly and hence tracked vehicle.

According to an aspect of the drive sprocket member, at least one tooth member of said set of tooth members comprises a resilient support portion having said resilient properties, and an engagement portion for engagement with said endless track, wherein said resilient support portion is configured to be arranged in connection to said ring-shaped support member and, in the operation position of said tooth member, project from said support member in said main direction essentially parallel to the axial direction of said centre axis, and wherein said engagement portion is configured to be supported by said support portion and project from said support portion so as to engage with said endless track in said operation position. According to an aspect of the present disclosure, each tooth member of said set of tooth members comprises such a resilient support portion and engagement portion. By thus providing tooth members having such resilient support portion and engagement portion, efficient deformation such as elastic deformation and/or plastic deformation based on radial force against tooth member and efficient engagement is facilitated. According to an aspect of the present disclosure, when said tooth member is in the operation position, said engagement portion is configured to project from said support member in said main direction essentially parallel to the axial direction of said centre axis. According to an aspect of the present disclosure, when said tooth member is in the operation, said engagement portion is configured to project from said support member in said main direction further away from said ring-shaped support member. According to an aspect of the present disclosure, the length, i.e. the distance of the main direction of extension, of the support portion of the tooth member is in the range of 25% to 75%, according to an aspect in the range of 40% to 60% of the length of said tooth member. According to an aspect of the present disclosure, the length, i.e. the distance of the main direction of extension, of the engagement portion of the tooth member is in the range of 25% to 75%, preferably in the range of 40% to 60% of the length of said tooth member. According to an aspect the length of the support portion and the length of the engagement portion corresponds to the length of the toot member.

According to an aspect of the present disclosure, said support portion of said tooth member may have any suitable radial thickness for facilitating said resilient properties. According to an aspect of the present disclosure, said support portion of said tooth member has an average radial thickness, i.e. thickness in the radial direction when arranged in connection to said ring-shaped support member and projecting in a main direction essentially parallel to said centre axis, in the range of 5% to 15%, preferably about 7% to 12% of the length of a tooth member. According to an aspect of the present disclosure, the average radial thickness of the support portion of the tooth member essentially corresponds to the axial thickness of said ring-shaped support member. According to an aspect of the present disclosure, said support portion of said tooth member has a variable radial thickness, wherein said radial thickness is configured to change linearly or non-linearly along the main extension of said support portion of said tooth member so as to provide desired resilient properties and even material tension.

According to an aspect of the drive sprocket member, said support portion of said toot member has a tapering configuration from said ring-shaped support member to said engagement portion, so as to facilitate said resilient properties in the radial direction, such that if said tooth member, i.e. said engagement portion of said tooth member, is subjected to a radial force exceeding a certain threshold, deformation of said tooth member is facilitated.

According to an aspect of the drive sprocket member, said support portion of said tooth member has a tapering configuration from said ring-shaped support member towards the engagement portion, said tapering configuration having a curvature adapted so as to obtain desired resilient properties and material tensions, such that if said tooth member, i.e. an engagement portion of said tooth member, is subjected to a radial force exceeding a certain threshold, deformation of said support portion of said tooth member is facilitated. According to an aspect of the drive sprocket member said curvature of said tapering configuration of said support portion of said tooth member, has a linear portion and/or an exponential portion and/or a parabolic portion, e.g. according to the elastic curvature of a beam.

According to an aspect of the drive sprocket member, said support portion of said tooth member has a curvature configuration from said ring-shaped support member towards the engagement portion adapted so as to obtain desired resilient properties and material tensions, such that if said tooth member is subjected to a radial force exceeding a certain threshold, deformation of said support portion of said tooth member is facilitated. According to an aspect of the drive sprocket member said curvature configuration of said support portion tooth member, has a linear portion and/or an exponential portion and/or a parabolic portion.

According to an aspect of the drive sprocket member, said support portion of said tooth member has a tapering configuration from said ring-shaped support member in its main direction so as to facilitate high stiffness of the tooth member in the tangential direction of said ring shaped support member and resilient properties for deformation of said tooth member in the radial direction.

According to an aspect of the drive sprocket member, said support portion of said toot member has a tapering configuration from said ring-shaped support member to said engagement portion, where said support portion has a first width at said support member extending essentially orthogonal to said radial direction and its axial direction, and a correspondingly extending second width at said engagement portion, said first width being wider than said second width of said support portion. Said support portion of said toot member thus has a funnel configuration, tapering from said ring-shaped support member to said engagement portion. Hereby is facilitated both high stiffness of said tooth members in the tangential direction of said ring shaped support member and said resilient properties for elastic and plastic deformation of said tooth members. According to an aspect of the present disclosure, said width of said support portion of said tooth member may be denoted tangential width or circumferential width. According to an aspect of the present disclosure, said support portion of said tooth member has a dovetail-shaped configuration. According to an aspect of the drive sprocket member, said support portion of said toot member has a width dimensioned so as to withstand expected tangential forces. According to an aspect of the drive sprocket member, said support portion of said toot member has a width configured to change along the extension of said support portion of said tooth member so as to provide tangential stiffness, having a wider width in connection to said ring-shaped support member, and facilitate resilient properties of said support portion of said tooth member. The wider portion of said support portion of said tooth member in connection to said ring-shaped support member facilitates said high stiffness in the tangential direction. According to an aspect of the present disclosure, said second width is in the range of 15% to 50% of said first width, according to an aspect in the range of 20% to 35% of said first width. According to an aspect of the present disclosure, said first width is in the range of 15% to 50% of the radial distance to the entire radial distance between the main direction of extension of a tooth member and the centre axis, according to an aspect in the range of 20% to 35% of the radial distance between the main direction of extension of said tooth member and the centre axis. Hereby controlled radial deformation, when said tooth member is subjected to a radial force exceeding a certain threshold, is facilitated due to said thus provided tangential stiffness.

According to an aspect of the drive sprocket member, said support portion is configured to radially taper in its extension from said ring-shaped support member to said engagement portion so that the radial thickness of said support portion at said support member is thicker than the radial thickness at said engagement portion. Hereby is facilitated both high stiffness of said tooth members in the tangential direction of said ring shaped support member and said resilient properties for elastic and plastic deformation of said tooth members. According to an aspect of the present disclosure, said support portion of said tooth member is configured to radially taper in its extension from said ring-shaped support member to said engagement portion with an average angle in the range of 2 degrees to 15 degrees preferably 4 degrees to 10 degrees. According to an aspect said support portion is configured to be arranged in connection to said ring-shaped support portion so that there is a curved transition from said ring-shaped support portion to said to said support portion of said tooth member. Said curved transition is according to an aspect within the first 20% of the extension of said support portion towards said engagement portion of said tooth member. Said transition from said ring-shaped support portion to said support portion of said tooth member has an L-shaped configuration when viewed in the tangential direction, i.e. towards the longitudinal side of the tooth member. According to an aspect of the present disclosure, said curved transition from said ring-shaped support portion to said to said support portion of said tooth member is shaped and dimensioned so as to provide contribution of said resilient properties of said support portion of said tooth member.

According to an aspect of the drive sprocket member, said support portion has a radial outer side facing away from said centre axis, an opposite radial inner side, a first long side and an opposite second long side, said long sides running from said ring-shaped support member to said engagement portion, wherein said first and second long sides have an S-shaped configuration in a plane essentially orthogonal to its axial and radial extension so as to form said tapering shape. Hereby is facilitated both high stiffness of said tooth members in the tangential direction of said ring shaped support member and said resilient properties for elastic and plastic deformation of said tooth members.

According to an aspect of the drive sprocket member, said support portion has a first portion arranged at said ring-shaped support member, said first portion being configured to radially extend from a radial outer portion of said support member and extend along the outer circumference of said support member so as to provide stiffness of said toot member in the tangential direction of said support member. Hereby high stiffness of said tooth members in the tangential direction is provided.

According to an aspect of the drive sprocket member, said support portion has a second portion arranged at and providing a transition to said engagement portion, said support portion further comprising an intermediate portion arranged between said first portion and second portion, wherein, in said operation position of said tooth member, said intermediate portion is configured to taper in its extension from said ring-shaped support member to said engagement portion in a plane essentially orthogonal to the axial and radial extension. Hereby said resilient properties for elastic and plastic deformation of said tooth members are facilitated.

According to an aspect of the drive sprocket member, said tooth member comprises a topographic geometric configuration arranged in connection to the transition from said support member to said resilient support portion so as to even out stiffness differences and/or optimize elastic properties of said tooth member. According to an aspect of the present disclosure, said topographic geometric configuration is configured to be provided by means of a relatively shallow recess running from an essentially from a transversal end side of said support member centrally into the radial inner side of said support portion of said tooth member. According to an aspect of the present disclosure, said recess has a first end side at said support member, an opposite second end side at said transition to said engagement portion, opposite inner long sides at least partly following the outer long sides of said support portion, and a bottom portion. By thus providing such a topographic geometric configuration, e.g. recess, the difference in stiffness of the tooth member in connection to the transition from the support member to the support portion of the tooth member may be efficiently evened out. By thus providing such a topographic geometric configuration, e.g. recess, the elastic properties of the tooth member in connection to the transition from the support member to the support portion of the tooth member may be efficiently evened out.

According to an aspect of the drive sprocket member, said second portion of said support portion is configured to provide said transition to said engagement portion so that, when said tooth member is in the operation position, a radial outer side of said engagement portion is radially further away from said centre axis than a radial outer side of said support portion. Herby, when the tooth member is subjected to an axial force in the direction towards said support member, a component of the force in radially outer direction away from the centre axis is provided, which is desirable. This is due to e.g. the endless track, i.e. the tension of the endless track and the weight of the tracked vehicle, acting as facilitator and support surface when said tooth members resiliently move in outer radial direction.

According to an aspect of the drive sprocket member, said engagement portion has a radial outer side which, when said tooth member is in the operation position, in connection to engagement with said endless track is configured to face a radial inner side of said endless track, wherein said tooth member is configured such that if one or more objects, during operation of said tracked vehicle, are introduced between said radial inner side of said endless track and said radial outer side of said engagement portion so that said tooth member is subjected to a radial force, in the direction towards said centre axis, exceeding a certain threshold, said tooth member is configured to deform relative to its operation position so that said at least one object is allowed to escape. Hereby the damages to the endless track and tooth members due to ingestion of undesired objects such as gravel and stones in between drive wheel member and endless track may be efficiently reduced.

According to an aspect of the drive sprocket member, said engagement portion has a U-shaped configuration, said engagement portion having wall portions configured to extend in the axial main extension of said toot member, and a bottom portion from which said wall portions are configured to protrude, said bottom portion having a radial outer side facing away from said centre axis. Hereby reduction of weight of said tooth members is facilitated. Further, efficient engagement with said endless track is facilitated.

According to an aspect of the drive sprocket member, the inner surface of said U-shaped engagement portion is formed such that there is a variation of the thickness of the U-shaped engagement portion, so as to increase the elastic properties of said engagement portion. According to an aspect of the present disclosure the formation of the inner surface of said U-shaped engagement portion is such that the respective wall portion and/or the bottom portion is configured to taper from said transition from the support portion along its main extension towards its end side. According to an aspect of the present disclosure the formation of the inner surface of said U-shaped engagement portion is such that the inner transition from the respective wall portion to the bottom portion has an arc-shaped or angled form so that the thickness in connection to said transitions is greater than the thickness of the central portion of the bottom portion. By thus providing such formation of the inner surface of said U-shaped engagement portion, increased elastic properties of said U-shaped engagement portion may be efficiently obtained.

According to an aspect of the drive sprocket member, said wall portions of said U-shaped engagement portion may according to an embodiment be shredded with thin cuts from its outer side towards the bottom portion in a plane orthogonal to its longitudinal extension, so as to locally reduce the stiffness of said engagement portion. Such shredding may be obtained by means of laser cutting. By thus providing such cut outs in said wall portion, the stiffness of said engagement portion may be efficiently reduced.

According to an aspect of the drive sprocket member, one or more tooth members of said set of tooth members are configured to be an integrated portion of said ring-shaped support member. According to an aspect of the drive sprocket member, the tooth members of said sprocket member are configured to be an integrated portion of said ring-shaped support member. By thus providing a drive sprocket member where tooth members and ring-shaped support member form an integrated portion, easy manufacturing is facilitated. According to an aspect of the present disclosure, said drive sprocket member is configured to be manufactured as one single piece.

According to an aspect of the drive sprocket member, said resilient support portion is configured to be an integrated portion of said ring-shaped support member.

According to an aspect of the drive sprocket member, said engagement portion is configured to be an integrated portion of said resilient support portion.

According to an aspect of the drive sprocket member, said engagement portion is configured to be attached to said resilient support portion.

According to an aspect, the drive sprocket member further comprises one or more sheet metal elements configured to be arranged internally around said drive sprocket member in connection to at least parts of the transversal end side of said support member from which said tooth member is projecting and at least parts of the radial inner side of said tooth member, said one or more sheet metal elements being arranged so as to increase the spring force. Said one or more sheet metal elements are thus arranged so as to increase the spring force of said tooth members. Such a sheet metal element is according to an aspect a separate element configured to be mounted in connection to said transversal end side of said support member and radial inner side of said tooth members. Said one more sheet metal elements may be assembled to said transversal end side of said support member and radial inner side of said tooth members in any suitable way, e.g. by means of joint members and/or folding of said one or more sheet metal elements in connection to tooth members and/or said support member. Said mounting of said one or more sheet metal elements may be provided with pre-tension or without pre-tension. Pre-tensioning may be utilized in order to increase the spring force of the respective tooth member essentially without losing any substantial resilience distance of the respective tooth member.

According to an aspect, the drive sprocket member may, according to an embodiment, further comprise a support ring configured to be arranged around said set of tooth members in connection to the radial inner side of said tooth members at the transition from said support portion to said engagement portion so as to increase the radial stiffness of said set of tooth members. Hereby the radial stiffness of said set of tooth members may be efficiently increased to a desired stiffness if desired. According to an aspect of the present disclosure, said support ring may have resilient properties so as to deform when subjected to a radial force in the direction towards said centre axis. According to an aspect of the present disclosure, said support ring may have resilient properties so as to elastically deform when subjected to a radial force in the direction towards said centre axis. According to an aspect of the present disclosure, said support ring may have resilient properties so as to plastically deform when subjected to a radial force in the direction towards said centre axis exceeding a predetermined threshold. According to an aspect of the present disclosure, said support ring may be of the same material as said tooth members. According to an aspect of the present disclosure, said support ring may be a separate part of said sprocket member, thus attachable in connection to the radial inner side of said tooth members at the transition from said support portion to said engagement portion.

Specifically, an object of the invention is achieved by a drive wheel member comprising at least one drive sprocket member as set out herein.

According to an aspect of the drive wheel member, said drive wheel member comprises a hub member for facilitating said rotation of said drive wheel member, wherein said drive wheel member comprises a transversal outer drive sprocket member arranged in connection to a transversal outer side of the hub member and a transversal inner drive sprocket member arranged in connection to a transversal inner side of the hub member, the transversal outer side facing out from a vehicle in the transversal direction of the tracked vehicle and the transversal inner side facing in the opposite transversal direction of the tracked vehicle to which the drive wheel member is mounted.

Specifically, an object of the invention is achieved by a tracked vehicle comprising a drive sprocket member as set out herein.

### BRIEF DESCRIPTION OF THE FIGURES

For a better understanding of the present disclosure, reference is made to the following detailed description when read in conjunction with the accompanying drawings, wherein like reference characters refer to like parts throughout the several views, and in which:

FIG. 1 schematically illustrates a side view of a tracked vehicle according to an embodiment of the present disclosure;

FIG. 2 schematically illustrates a perspective view of a portion of a tracked vehicle with drive wheel member and portion of the endless track of a track assembly according to an embodiment of the present disclosure;

FIG. 3 schematically illustrates a side view of the drive wheel member in FIG. 2 according to an embodiment of the present disclosure;

FIG. 4 schematically illustrates a perspective view of a drive sprocket member of a drive wheel member for an endless track of a tracked vehicle according to an embodiment of the present disclosure;

FIG. 5 schematically illustrates a perspective view of a portion of the drive sprocket member in FIG. 4, focusing on a tooth member, according to an embodiment of the present disclosure;

FIG. 6 schematically illustrates a front view of the drive sprocket member in FIG. 4, according to an embodiment of the present disclosure;

FIG. 7a schematically illustrates a cross sectional side view of a tooth member of the drive sprocket member in FIG. 6, according to an embodiment of the present disclosure;

FIG. 7b schematically illustrates the cross sectional side view of the tooth member in FIG. 7a, where the tooth member has been subjected to a radial force causing a deformation of the tooth member, according to an embodiment of the present disclosure;

FIG. 8 schematically illustrates a perspective view of a portion of a drive sprocket member, focusing on a tooth member, according to an embodiment of the present disclosure;

FIG. 9a schematically illustrates a side view of a portion of a drive sprocket member according to an embodiment of the present disclosure; and,

FIG. 9b schematically illustrates a front view of the drive sprocket member in FIG. 9a, according to an embodiment of the present disclosure;

FIG. 10 schematically illustrates a perspective view of an engagement portion of a tooth member, according to an embodiment of the present disclosure; and,

FIG. 11 schematically illustrates a perspective view of an engagement portion of a tooth member, according to an embodiment of the present disclosure.

### DETAILED DESCRIPTION OF THE DISCLOSURE

Herein the term “elastic deformation” corresponds to a deformation of a portion where said deformed portion returns to its position prior to the deformation.

Herein the term “plastic deformation” corresponds to a deformation of a portion where said deformed portion essentially remains in the deformed position, where it according to an aspect is retained and may be returned to its original position prior to the deformation.

Herein the term “threshold” may be denoted “threshold value”.

Herein the term “rubber” in relation to “rubber track” refers to any elastic material such as rubber, elastomers or combinations of rubber and elastomers.

Herein the term “centre axis” when referring to the axis about which a drive wheel member of a tracked vehicle is configured to be rotatable about, refers to an imaginary axis, which when referred to, may have an imaginary axial extension relative to the drive wheel member.

According to an aspect of the present disclosure a drive sprocket member for a drive wheel member for an endless track of a tracked vehicle is provided. The drive sprocket member is configured for facilitating preventing damages to the endless track and drive wheel member. The drive sprocket member is according to an aspect of the present disclosure configured for facilitating maintenance of the drive wheel member. The drive sprocket member is according to an aspect of the present disclosure configured for facilitating repairing of tooth members of a drive sprocket member of the drive wheel member.

Such a tracked vehicle has a longitudinal extension and a transversal extension. The longitudinal extension of said tracked vehicle is corresponding to the length of the tracked vehicle and the transversal extension of the tracked vehicle is corresponding to the width of tracked vehicle. Such a tracked vehicle further has a certain height extending in a direction orthogonal to the longitudinal and transversal extension of said tracked vehicle. The longitudinal extension of said tracked vehicle is normally corresponding to the driving direction of the vehicle, i.e. forward or rear driving direction.

Such a tracked vehicle may comprise a right track assembly and a left track assembly for driving the vehicle. Each track assembly may comprise a drive wheel member, a tension wheel, a set of road wheels and an endless track arranged to run over said wheels, i.e. surround said wheels. The endless track of the respective track assembly may be arranged to be driven and hence rotated by means of said drive wheel member. The endless track of the respective track assembly may be arranged to be driven and hence rotated by means of one or more drive sprocket members of said drive wheel member. The drive wheel member and hence said one or more drive sprocket members are configured to be rotatable about a centre axis for rotating said endless track. Said centre axis refers to an imaginary axis in the centre of the respective drive wheel member and hence drive sprocket member of the tracked vehicle, said centre axis running in the transversal direction of the tracked vehicle when drive said drive wheel members are attached to the tracked vehicle. The tracked vehicle may comprise drive means for driving said drive wheel members. The drive means may be any suitable drive means such as one or more internal combustion engines and/or one or more electric machines.

The endless track of the respective track assembly may have any suitable configuration and be of any suitable material. The endless track of the respective track assembly may according to an aspect of the present disclosure be a rubber track. The endless track of the respective track assembly may according to an aspect of the present disclosure be a steel track.

The drive wheel member comprises a centrally arranged hub member and a drive sprocket member. The drive sprocket member is configured to be attached to the hub member.

According to an aspect of the present disclosure said drive wheel member comprises a transversal outer drive sprocket member arranged on the transversal outer side of the hub member and a transversal inner drive sprocket member arranged on the transversal inner side of the hub member. The transversal outer side of the hub member is facing away from a vehicle, i.e. away from vehicle body/transversally opposite drive wheel member, in the transversal direction of the vehicle and the inner side of the hub member is facing towards the vehicle, i.e. towards vehicle body/transversally opposite drive wheel member, in the transversal direction of the tracked vehicle to which the drive wheel member is mounted.

According to an aspect of the present disclosure said hub member has a front side or transversal outer side configured to face transversally out from the side of the vehicle and an opposite rear side or transversal inner side configured to face transversally towards the side and opposite side of the vehicle when the drive wheel member is mounted to the tracked vehicle, i.e. mounted to the track assembly of the tracked vehicle.

The drive sprocket member comprises a set of tooth members arranged around the circumference of said drive sprocket member. Said tooth members are configured to engage with said endless track. Said drive sprocket member further comprises a ring-shaped support member for tooth members of said drive sprocket member. Said tooth members are configured to project from the ring-shaped support member in a main direction essentially parallel to the axial direction of said centre axis so that said tooth members are in an operation position for engaging with said endless track. Said tooth members are arranged in connection to said ring-shaped support member and shaped so as to provide resilient properties in the radial direction. Thus, said drive sprocket member are shaped so that they comprise deformation properties comprising resilient properties for said tooth members.

Said tooth members are configured so that, if a tooth member of said set of tooth members is subjected to a radial force in the direction towards said centre axis exceeding a certain threshold, said tooth member is configured to deform. Such a radial force may be caused by one or more objects introduced between a radial inner side of said endless track and a radial outer side of said tooth member.

If said radial force exceeds a certain threshold and up to a predetermined threshold, said tooth member is configured to elastically deform relative to its operation position so that, when said tooth member is no longer subjected to said radial force, said tooth member returns to its operation position due to said elastic deformation.

If said radial force exceeds said predetermined threshold, said tooth member is configured to plastically deform relative to its operation position so that, when said tooth member is no longer subjected to said radial force, said tooth member essentially remains in its plastically deformed position.

When said drive wheel member is arranged at the tracked vehicle, a set of the tooth members of the drive sprocket member may be engaged with the endless track and another set of the tooth members of the drive sprocket member may be at a rotated position of the drive wheel member so that they are not engaged with the endless track and may thus be repaired by returning the one or more tooth members to the operation position, should one or more of them have been subjected to a radial force causing such a plastic deformation. The drive wheel member may then be rotated to another rotated position of the drive wheel member so that another set of the tooth members of the drive sprocket member is not engaged with the endless track and may thus, if necessary, i.e. if plastically deformed, be correspondingly repaired.

According to an aspect of the present disclosure, said tooth members may be manufactured in any suitable material for facilitating such deformation. According to an aspect of the present disclosure, said tooth members may be manufactured in any suitable steel material for facilitating such deformation. The material of said tooth members of said sprocket member may be any suitable material facilitating the above-mentioned properties, comprising resilient properties. The material may, for example, be any of: conventional metals comprising steel; super elastic alloys; metal matrix composites; amorphous metals; polymer based composites; Shape Memory Alloys (SMA) metals; Carbon Nano Tubes (CNT) or other materials based on nanotechnology. According to an aspect of the present disclosure, said tooth members may be manufactured in any suitable spring steel material for facilitating such deformation. According to an aspect of the present disclosure, said tooth members may be manufactured in steel materials facilitating welding, for facilitating such deformation. According to an aspect of the present disclosure, said tooth members may be manufactured in a press hardened Boron alloyed steel material for facilitating such deformation.

According to an aspect of the present disclosure, at least the portion of said tooth members arranged in connection to said ring shaped support member, are configured to be an integrated part of said ring shaped support member of said drive sprocket member.

According to an aspect of the present disclosure, said tooth members are configured to be an integrated part of said ring shaped support member of said drive sprocket member. According to an aspect of the present disclosure, said tooth members are configured to be connected to each other at said support member so as to facilitate transfer of said resilient properties between adjacent tooth members. According to an aspect of the present disclosure, said tooth members are configured to be connected to each other so that they form a ring-shaped member at the ring-shaped support member/of the ring-shaped support member. According to an aspect of the present disclosure, said tooth members are configured to radially project at the radial outer portion of said support member and so that recesses are provided between adjacent tooth members at said support member.

According to an aspect of the present disclosure, said drive sprocket member may be manufactured in any suitable material for facilitating such deformation of tooth members. According to an aspect of the present disclosure, said drive sprocket member may be manufactured in any suitable steel material for facilitating such deformation of tooth members. The material of said ring-shaped sprocket member may be any suitable material facilitating the above mentioned properties, comprising resilient properties. The material may, for example, be any of: conventional metals comprising steel; super elastic alloys; metal matrix composites; amorphous metals; polymer based composites; Shape Memory Alloys (SMA) metals; Carbon Nano Tubes (CNT) or other materials based on nanotechnology. According to an aspect of the present disclosure, said drive sprocket member may be manufactured in any suitable spring steel material, for facilitating such deformation of tooth members. According to an aspect of the present disclosure, said drive sprocket member may be manufactured in steel materials facilitating welding, for facilitating such deformation of tooth members. According to an aspect of the present disclosure, said drive sprocket member may be manufactured in a press hardened Boron alloyed steel material for facilitating such deformation of tooth members.

According to an aspect of the present disclosure, said tooth members may be manufactured by means of any suitable manufacturing process for facilitating such deformation of the tooth members. The manufacturing method of said tooth members of said sprocket member may be any suitable manufacturing method facilitating providing the above-mentioned properties. Manufacturing methods may, for example, be any of: machining; casting; lamination; sintering; injection moulding; hot isotatic pressing; conventional forging; flow forming; additive manufacturing. According to an aspect of the present disclosure, said tooth members of said sprocket member may be manufactured by means said so called Flow Forming, i.e. an incremental rotation forging process where tools in the shape of rolls and high pressure roll out the material over a cylindrical form tool. Hereby deformation hardening material may directly obtain suitable properties. In alternative processes, following heat treatment may be required. The drive sprocket member according to the present disclosure may advantageously be manufactured as one single unit.

According to an aspect of the present disclosure, said drive sprocket member may be manufactured by means of any suitable manufacturing process for facilitating such deformation of the tooth members. The manufacturing method of said ring-shaped sprocket member may be any suitable manufacturing method facilitating providing the above-mentioned properties. Manufacturing methods may, for example, be any of: machining; casting; lamination; sintering; injection moulding; hot isotatic pressing; conventional forging; flow forming; additive manufacturing. According to an aspect of the present disclosure, said ring-shaped sprocket member may be manufactured by means said so called Flow Forming, i.e. an incremental rotation forging process where tools in the shape of rolls and high pressure roll out the material over a cylindrical form tool. Hereby deformation hardening material may directly obtain suitable properties. In alternative processes, following heat treatment may be required. The drive sprocket member according to the present disclosure may advantageously be manufactured as one single unit.

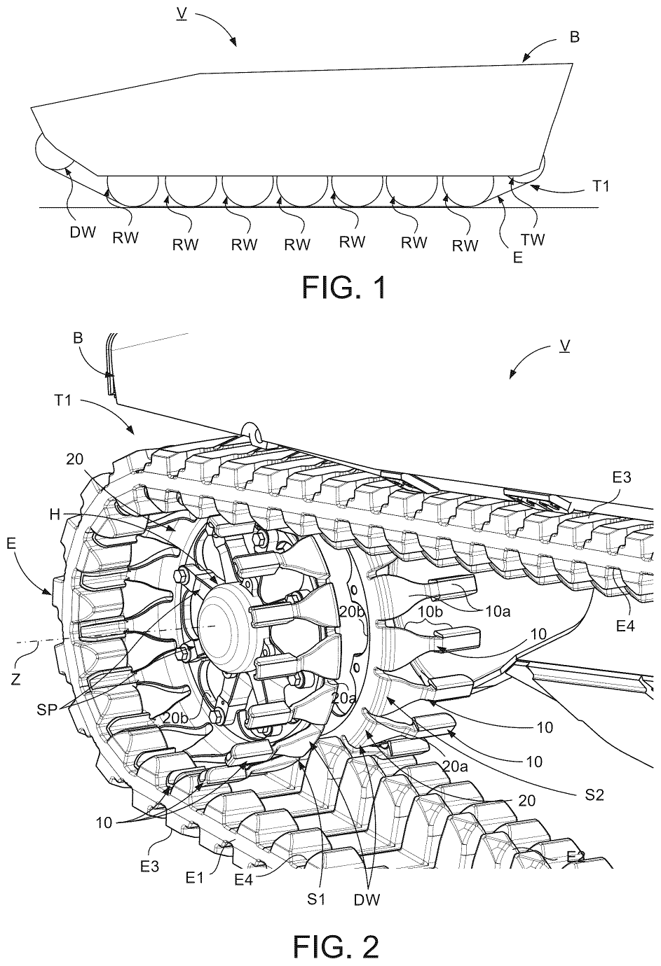

FIG. 1 schematically illustrates a side view of a tracked vehicle V according to an embodiment of the present disclosure.

The tracked vehicle V is according to the disclosure in FIG. 1 a military vehicle. The tracked vehicle V is according to the disclosure in FIG. 1 a combat vehicle.

The tracked vehicle V comprises a vehicle body B, which according to an aspect of the present disclosure comprises the chassis of the vehicle V and bodywork.

The tracked vehicle V comprises a right track assembly and a left track assembly T1 for driving the vehicle V, the left track assembly being shown in FIG. 1. Each track assembly has a longitudinal extension and the right track assembly is configured to run in connection to the right side along the longitudinal extension of the vehicle body B of the vehicle V and the left track assembly is configured to run in connection to the left side along the longitudinal extension of the vehicle body B of the vehicle V. Each track assembly comprises a drive wheel member DW, a tension wheel TW, a set of road wheels RW and an endless track E arranged to run over said wheels. Here the drive wheel member DW is arranged in the front, the tension wheel TW is arranged in the back and the road wheels RW are arranged between the drive wheel member DW and the tension wheel TW. The tracked vehicle according to the present disclosure may however have track assemblies with any suitable arrangement of drive wheel member, tension wheel and road wheels. According to an aspect of the present disclosure the tension wheel may be arranged in the front, the drive wheel member arranged in the back and the road wheels arranged there between.

The endless track E of the respective track assembly is arranged to be driven and hence rotated by means of said drive wheel member DW. The tracked vehicle V comprises a drive means, not shown, for driving said drive wheel members DW. The drive means may be any suitable drive means such as an internal combustion engine and/or an electric machine.

The endless track of the respective track assembly may have any suitable configuration and be of any suitable material. The endless track E of the respective track assembly may, according to an aspect of the present disclosure, be a rubber track. The endless track of the respective track assembly may, according to an aspect of the present disclosure, be a steel track.

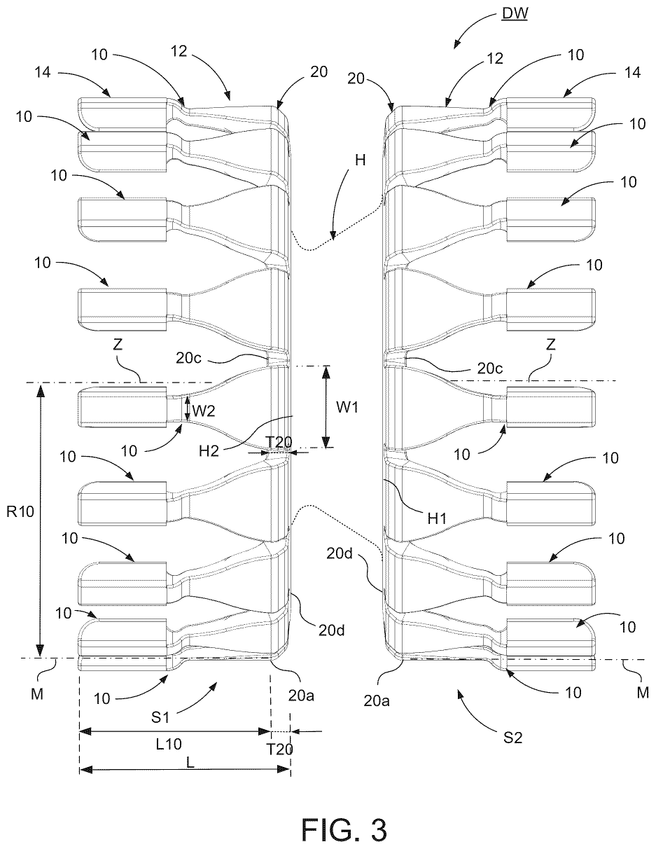

FIG. 2 schematically illustrates a perspective view of a portion of a tracked vehicle V with drive wheel member DW and portion of the endless track E of a track assembly T1 according to an aspect of the present disclosure. FIG. 3 schematically illustrates a side view of the drive wheel member DW in FIG. 2 according to an aspect of the present disclosure. The side view in FIG. 3 is a view towards a radial outer side of said drive wheel member DW.

The drive wheel member DW has a centre axis Z. The centre axis Z is running in the transversal direction of the tracked vehicle V. The centre axis Z is running in the transversal direction of the track assembly T1. The drive wheel member DW is configured to rotate about the centre axis Z. The drive wheel member DW comprises a hub member H. The hub member H is configured to be operably engaged with the drive axle of the drive means of the tracked vehicle and configured to be rotated by the drive means. The hub member H is thus arranged to rotate about the centre axis Z, see FIG. 3.

The hub member H has according to this embodiment spokes SP. The hub member according to the present disclosure may have any suitable configuration. The drive means may according to an aspect of the present disclosure, not shown, be arranged in connection to the drive wheel member such that the drive means, e.g. an electric machine, at least partly is accommodated within the periphery of the drive wheel member, the drive means axle essentially coaxially coinciding with the centre axis Z of the drive wheel member.

The hub member H has a transversal front side H1 and an opposite transversal rear side H2, see FIG. 3. The transversal front side H1 is configured to face out from the vehicle in the transversal direction of the vehicle and the transversal rear side H2 is configured to face in the transversal direction of the vehicle towards the opposite side of the vehicle, when the drive wheel member DW is mounted to the tracked vehicle V. The transversal front side H1 of the hub member may be denoted transversal outer side H1 of the hub member H since it faces outwardly from the vehicle in the lateral direction of the vehicle. The rear side H2 of the hub member may be denoted transversal inner side H2 of the hub member H since it faces inwardly in the lateral direction of the vehicle.

According to an aspect of the present disclosure said drive wheel member DW comprises a transversal outer ring shaped drive sprocket member S1 arranged in connection to the front side H1 of the hub member H and the transversal inner ring shaped drive sprocket member S2 arranged in connection to the rear side H2 of the hub member H. The respective drive sprocket member S1 is provided with a set of tooth members 10 configured to be arranged around the circumference of said ring shaped drive sprocket members S1, S2.

According to an aspect of the present disclosure the transversal outer drive sprocket member S1 is facing out from a vehicle in the transversal direction of the vehicle and the inner drive sprocket member S2 is facing towards the vehicle in the transversal direction of the vehicle to which the drive wheel member DW is mounted.

Said drive sprocket members S1, S2 may, according to an aspect of the present disclosure, be denoted drive wheels or drive wheel units. Said outer drive sprocket member S1 may, according to an aspect of the present disclosure, be denoted outer drive wheel or outer drive wheel unit. Said inner drive sprocket member S2 may, according to an aspect of the present disclosure, be denoted inner drive wheel or inner drive wheel unit.

The respective drive sprocket member S1, S2 comprises a set of tooth members 10 arranged around the circumference of said drive sprocket member S1, S2.

According to the embodiment illustrated in FIG. 2, the transversal outer drive sprocket member S1 comprises a set of tooth members 10 arranged around the circumference of said outer drive sprocket member S1. Said tooth members 10 of said outer drive sprocket member S1 are configured to project transversely outwardly in a main direction essentially parallel to the axial direction of said centre axis Z so that said tooth members 10 are in an operation position for engaging with said endless track E.

According to the embodiment illustrated in FIG. 2, the transversal inner drive sprocket member S2 comprises a set of tooth members 10 arranged around the circumference of said transversal inner drive sprocket member S2. Said tooth members 10 of said inner drive sprocket member S2 are configured to project transversely inwardly in a main direction essentially parallel to the axial direction of said centre axis Z so that said tooth members 10 are in an operation position for engaging with said endless track E.

The endless track E of the respective track assembly T1 of the tracked vehicle V has a transversal outer side E1 facing out from a vehicle in the transversal direction of the vehicle and a transversal inner side E2 facing towards the vehicle in the transversal direction of the vehicle to which the track assembly is mounted, see FIG. 2. The transversal outer side E1 and transversal inner side E2 are facing in a direction corresponding to the direction of said centre axis Z.

The endless track E of the respective track assembly T1 of the tracked vehicle V has an outer side E3 facing away from the drive wheel member DW when the track is engaging with the drive wheel member DW and an inner side E4 facing towards the drive wheel member DW when the track is engaging with the drive wheel member DW, see FIG. 2. The outer side E3 is a ground engaging outer side E3, a portion of said ground engaging outer side E3 being configured to engage with the ground, the portion changing during drive and thus rotation of the track E. The inner side E4 is a drive wheel engaging inner side E4, a portion of said drive wheel engaging inner side E4 being configured to engage with the drive wheel member DW, the portion changing during drive and thus rotation of the track E. The ground engaging outer side E3 and the opposite drive wheel engaging inner side E4 of the endless track E are thus facing in a direction orthogonal to the direction of the transversal outer side E1 and transversal inner side E2 of the endless track E. The endless track E is configured to surround wheels of the vehicle, see e.g. FIG. 1, including said drive wheel member DW so that said inner side E4 is facing said wheels.

Said tooth members are 10 configured to engage with an endless track of the tracked vehicle. The endless track E illustrated in FIG. 2, are illustrated with recesses on the inner side E4 for said engagement with said tooth members 10.

The respective drive sprocket member S1, S2 comprises a ring-shaped support member 20 for tooth members of said drive sprocket member S1, S2. According to this embodiment, the transversal outer drive sprocket member S1 comprises a support member 20 for tooth members 10 of said transversal outer drive sprocket member S1. According to this embodiment, the transversal inner drive sprocket member S2 comprises a support member 20 for tooth members 10 of said transversal inner drive sprocket member S2.

The support member 20 of the respective drive sprocket member S1, S2 has, according to an aspect of the present disclosure, a ring shaped configuration. The support member 20 of the respective drive sprocket member S1, S2 has a radial outer side 20a facing outwardly away from said centre axis Z and an opposite radial inner side 20b facing inwardly towards said centre axis Z. According to an aspect of the present disclosure, the ring-shaped support member 20 has an outer diameter with said outer side and an inner diameter with said inner side. The radial outer side 20a of said support member 20 is configured to face said drive wheel engaging inner side E4 of said track E when said drive wheel member DW is engaging with said track E.

The support member 20 of the respective drive sprocket member S1, S2 has a first transversal end side 20c and an opposite second transversal end side 20d. The first end side 20c and opposite second end side 20d are configured to face in the direction parallel to the direction of said centre axis Z. The transversal first end side 20c and opposite transversal second end side 20d of the support member 20 are configured to face in the transversal direction of said tracked vehicle when said drive wheel member DW and hence track assembly is attached to the tracked vehicle.

The transversal first end side 20c of the ring-shaped support member 20 of the transversal outer drive sprocket S1 is configured to face away from the transversal front side H1 of the hub member H when attached to the hub member H. The transversal first end side 20c of the support member 20 of the transversal inner drive sprocket S2 is configured to face away from the transversal rear side H2 of the hub member H when attached to the hub member H.

The transversal first end side 20c of the support member 20 of the transversal outer drive sprocket S1 is configured to face in the same direction as the transversal outer side E1 of the endless track E when the drive wheel member is connected to the endless track E. The transversal first end side 20c of the support member 20 of the inner drive sprocket S2 is configured to face in the same direction as the transversal inner side E2 of the endless track when the drive wheel member is connected to the endless track. The transversal first end side 20c of the ring-shaped of the respective drive sprocket S1, S2 is thus configured to face away from the endless track in a direction essentially parallel to the direction of the centre axis Z.

The transversal first end side 20c of the ring-shaped support member 20 of the respective drive sprocket S1, S2 are thus configured to face away from each other. The transversal first end side 20c of the ring-shaped support member 20 of the outer drive sprocket S1 is thus configured to face away from the first end side 20c of the ring-shaped support member 20 of the inner drive sprocket S2.

The transversal second side 20d of the support member 20 of the transversal outer drive sprocket S1 is configured to face towards the transversal front side H1 of the hub member H when attached to the hub member H. The transversal second side 20d of the support member 20 of the transversal inner drive sprocket S2 is configured to face towards the transversal rear side H2 of the hub member H when attached to the hub member H.

The transversal second end side 20d of the support member 20 of the transversal outer drive sprocket S1 is configured to face away from the transversal outer side E1 of the endless track E when the drive wheel member is connected to the endless track E. The transversal second end side 20d of the support member 20 of the transversal inner drive sprocket S2 is configured to face away from the transversal inner side E2 of the endless track when the drive wheel member is connected to the endless track. The transversal second end side 20d of the ring-shaped support member 20 of the respective drive sprocket S1, S2 is thus configured to face towards the endless track in a direction essentially parallel to the direction of the centre axis Z.

The transversal second end side 20d of the ring-shaped support member 20 of the respective drive sprocket S1, S2 are thus configured to face towards each other. The transversal second end side 20d of the ring-shaped support member 20 of the transversal outer drive sprocket S1 is thus configured to face towards the transversal second end side 20d of the ring-shaped support member 20 of the transversal inner drive sprocket S2.

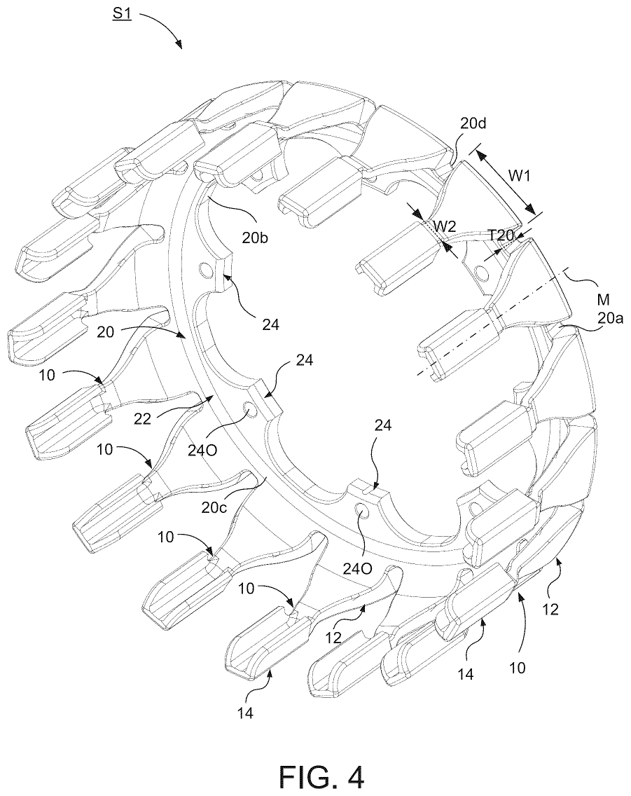

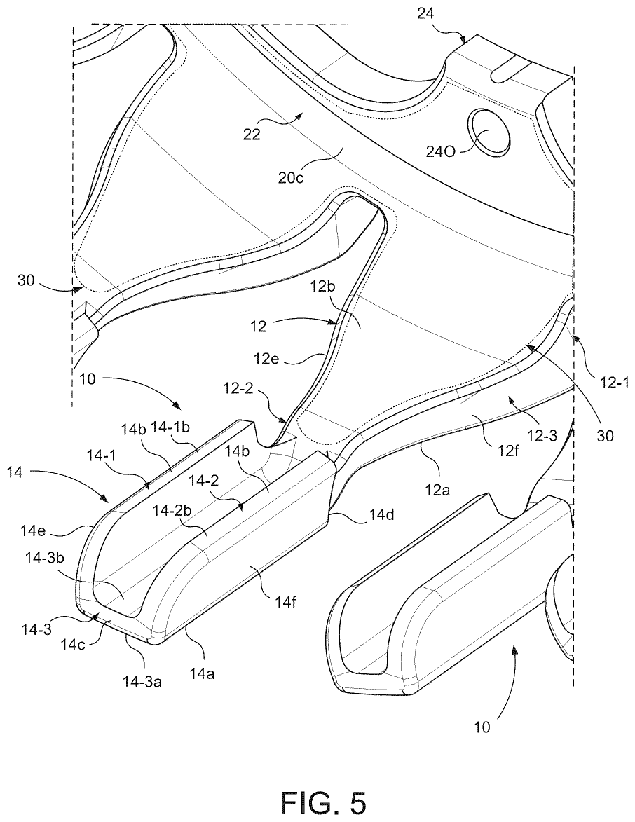

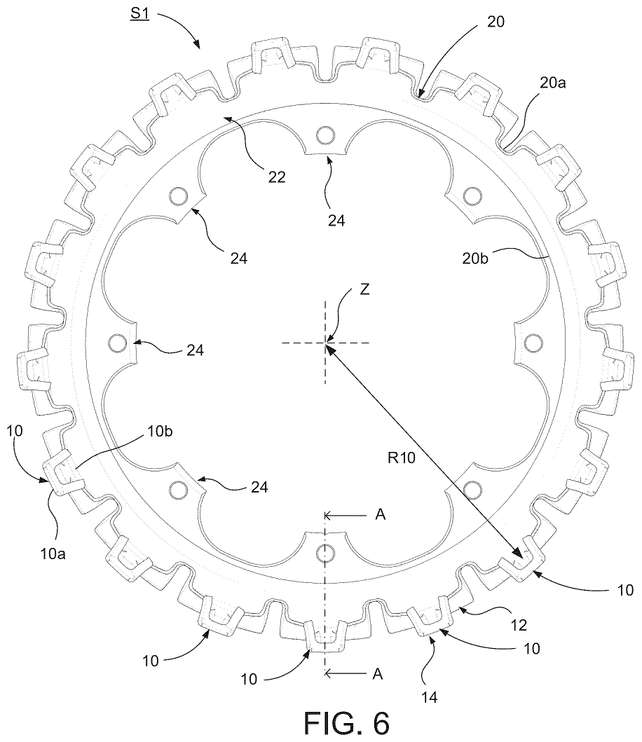

FIG. 4 schematically illustrates a perspective view of a drive sprocket member S1 for a drive wheel member for an endless track of a tracked vehicle according to an aspect of the present disclosure. Said drive sprocket member S1 comprises a ring-shaped support member 20. FIG. 5 schematically illustrates a perspective view of a portion of the drive sprocket member S1 in FIG. 4, focusing on a tooth member 10, according to an embodiment of the present disclosure. FIG. 6 schematically illustrates a front view of the drive sprocket member S1 in FIG. 4, according to an embodiment of the present disclosure. The drive wheel member comprising such a sprocket member S1 may be a drive wheel member according to the drive wheel member DW in FIG. 1. The drive wheel member comprising such a sprocket member S1 may be a drive wheel member according to the drive wheel member DW in FIG. 2.

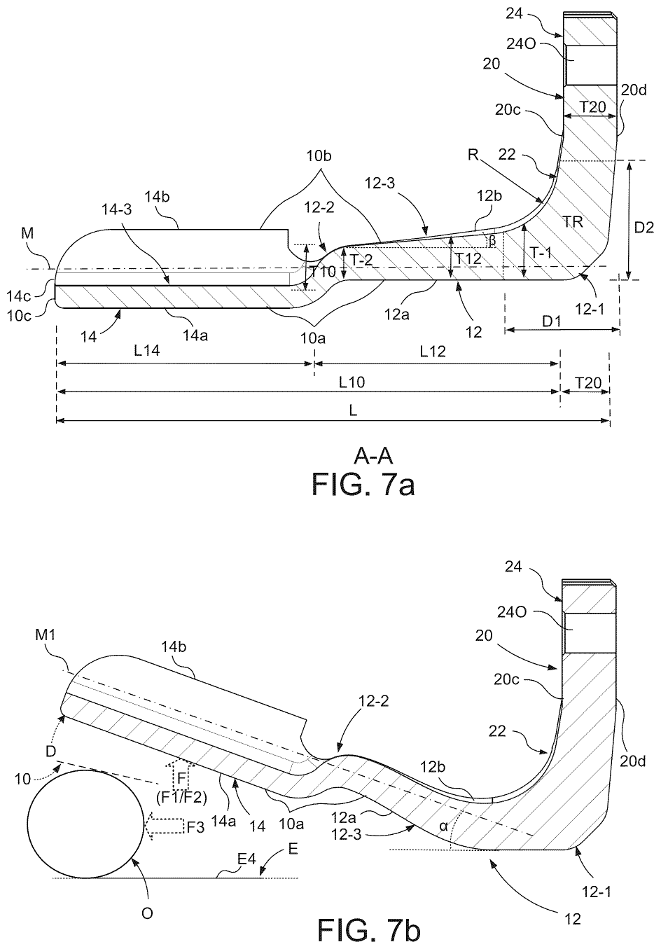

FIG. 7a schematically illustrates a cross sectional side view of a tooth member 10 of the drive sprocket member S1 in FIG. 6, according to an aspect of the present disclosure; and, FIG. 7b schematically illustrates the cross-sectional side view of the tooth member 10 in FIG. 7a, where the tooth member 10 has been subjected to a radial force F causing a deformation of the tooth member 10, according to an aspect of the present disclosure.

Said tooth members 10 are configured to project from the ring-shaped support member 20 in a main direction M essentially parallel to the axial direction of said centre axis Z so that said tooth members 10 are in an operation position for engaging with said endless track E for facilitating said rotation of said endless track E, see e.g. FIGS. 3 and 7a. As illustrated in e.g. FIGS. 2 and 7a, said tooth members has a radial outer side 10a configured to face a radial inner side E4 of said endless track E when said tooth members 10 engage with said endless track E. As illustrated in e.g. FIGS. 2 and 7a, said tooth members has a radial inner side 10b configured to face inwardly towards said centre axis Z. According to the embodiment illustrated e.g. in FIGS. 3-6 and 7a-b, said tooth members 10 are an integrated part of said ring-shaped support member 20.

As illustrated in e.g. FIG. 3, said tooth members 10, arranged on and distributed around the support member 20 of the respective drive sprocket member S1, S2, are configured to project from said first end side 20c of said support member 20 in said main direction, when being in their operation position.

Said tooth members 10 are configured to project from the ring-shaped support member 20, in connection to a radial outer side 20a of said ring-shaped support member 20, see e.g. FIG. 4, in a main direction M essentially parallel to the axial direction of said centre axis Z, ending at a predetermined distance away from said ring-shaped support member. Said tooth members 10 have an end side 10c furthest away from said ring-shaped support member, see e.g. FIG. 7a, wherein the length L10, i.e. the distance of the main direction of extension, of the respective tooth member 10 corresponds to the distance from the ring-shaped support member 20 where the tooth member 10 projects to the end side 10c of said tooth member 10.

According to an aspect of the present disclosure, the length of the tooth member is in the range of 30% to 100% of the radial distance R10 between the main direction of extension M of a tooth member 10 and the centre axis Z, according to an aspect in the range of 60% to 80% of the radial distance R10 between the main direction of extension of said tooth member 10 and the centre axis Z, see e.g. FIG. 5.

According to an aspect of the present disclosure, said ring-shaped support member 20 has an average axial thickness T20, i.e. a thickness in the direction essentially parallel to the axial direction of said centre axis Z, see e.g. FIGS. 4, 5 and 7a. According to an aspect of the present disclosure, said average axial thickness T20 of said ring-shaped support member 20 is in the range of 5% to 20%, according to an aspect about 7% to 15% of the length L10 of a tooth member 10.

According to an aspect of the present disclosure, said tooth members 10 have an average radial thickness T10, i.e. thickness in the radial direction when arranged around the circumference of said drive sprocket member, in the range of 5% to 15%, according to an aspect about 7% to 12% of the length of a tooth member. According to an aspect of the present disclosure, the average radial thickness T10 of the respective tooth member 10 essentially corresponds to the axial thickness T20 of said ring-shaped support member 20. According to an aspect of the present disclosure, said tooth members 10 have a variable radial thickness, wherein said radial thickness is configured to change linearly or non-linearly along the main extension M of said tooth member 10 so as to provide desired resilient properties and even material tension.

According to an aspect of the present disclosure, the respective drive sprocket member S1, S2 comprises a set of fastening members 24 arranged around the inner side 20b of the respective ring shaped support member 20, see FIGS. 4, 5 and 6, showing the set of fastening members 24 for the radial outer drive sprocket member S1. The respective fastening member 24 comprises or is arranged to receive a bolt joint member, not shown, for attaching the respective drive sprocket member S1, S2 to the hub member H of the drive wheel member DW. The respective fastening member 24 comprises a through hole 240 for receiving a bolt joint member for facilitating said attachment. According to an aspect of the present disclosure, the fastening members 24 are configured to be attached to spokes SP of the hub member H.

According to an aspect of the present disclosure, said fastening members 24 are comprised in said ring-shaped support member 20. According to an aspect of the present disclosure, said fastening members 24 constitute an integrated portion of said ring-shaped support member 20.

According to an aspect of the present disclosure, said ring-shaped support member 20 has an intermediate ring portion 22 arranged radially between said axially inner portion 12-1 of said tooth members 10, see e.g. FIG. 5 and FIGS. 7a-b, and said fastening members 24. According to the embodiment illustrated in e.g. FIG. 4, said tooth members 10, and said intermediate portion 22 and fastening members 24 form an integrated portion of said sprocket member S1.

According to an aspect of the present disclosure, as illustrated in e.g. FIG. 7a, the respective tooth member 10 is configured to be arranged in connection to said ring-shaped support member 20 so that there is a transition between said ring-shaped support member 20 and said tooth member 10 from an essentially radial extension of said ring-shaped support member 20 to said axial main extension M of said tooth member 10.

According to an aspect of the present disclosure, as illustrated in e.g. FIG. 7a, said transition from said radial extension of said ring-shaped support member 20 to said axial main direction of extension of said tooth member 10 has an L-shape with a slight curve.

According to an aspect of the present disclosure, as illustrated in e.g. FIG. 7a, said transition from said radial extension of said ring-shaped support member 20 to said axial main direction of extension of said tooth member 10 has a curved configuration, with an inner curve, e.g. essentially arc-shaped curve, from said transversal end side 20c of the ring-shaped support member 20 to the radial inner side 10b of said tooth member.

According to an aspect of the present disclosure, said transition TR has an extension such that the majority, e.g. at least 80% of the length L10 of said tooth member 10 has an axial main direction of extension essentially parallel to the axial extension of said centre axis Z. According to an aspect of the present disclosure, said transition TR has an extension such that the majority, e.g. at least 80% of the length L of said tooth member 10 to the end side 20d has an axial main direction of extension essentially parallel to the axial extension of said centre axis Z.

Said transition TR has according to an aspect an axial extension D1 from the end side 20d to the end of the transition in the outward axial direction. Said transition TR has according to an aspect radial extension D2 from the radial outer side 10a of the tooth member 10 to the end of the transition in the inward radial direction.

According to an aspect of the present disclosure, the axial extension D1 of said transition TR from the end side 20d to the end of the transition in the outward axial direction may be in the range of 10% to 30%, according to an aspect 15% to 25% of the length L of said tooth member 10 to the end side 20d.

According to an aspect of the present disclosure, the average radial thickness T10 of said tooth member 10 may be in the range of 20% to 50%, according to an aspect 30% to 40% of the radial extension D2 of said transition TR from the radial outer side 10a of the tooth member 10 to the end of the transition in the inward radial direction.

According to an aspect of the present disclosure, the radial extension D2 of said transition TR from the radial outer side 10a of the tooth member 10 to the end of the transition in the inward radial direction may be in the range of 10% to 30%, according to an aspect 15% to 25% of the radial distance R10 between the axial main direction M of extension of a tooth member 10 and the centre axis Z.

The drive wheel member according to the present disclosure may according to an alternative aspect of the present disclosure, not shown, be provided with a single drive sprocket member. The drive wheel member according to the present disclosure may according to an aspect of the present disclosure be provided with a single drive sprocket member, not shown, having tooth members arranged around the circumference of said single drive sprocket and one support member for said tooth members. The tooth members are configured to be arranged in connection to such a single ring-shaped support member and shaped so as to provide resilient properties in the radial direction such that, if a tooth member of said set of tooth members is subjected to a radial force, in the direction towards the centre axis of such a drive wheel member, exceeding a certain threshold, said tooth member is configured to deform relative to its operation position.

As illustrated in e.g. FIGS. 4, 5 and 7a-b, said tooth member 10 of said set of tooth members 10 comprises a resilient support portion 12 having said resilient properties. Said tooth member 10 further comprises an engagement portion 14 for engagement with said endless track E.

Said resilient support portion 12 is configured to be arranged in connection to said ring-shaped support member 20 and, in the operation position of said tooth member 10, project from said support member 20 in said main direction essentially parallel to the axial direction of said centre axis Z.

According to an aspect of the present disclosure, as illustrated in e.g. FIG. 7a, the respective tooth member 10 is configured to be arranged in connection to said ring-shaped support member 20 so that there is a transition TR between said ring-shaped support member 20 and said resilient support member 12 of said tooth member 10 from an essentially radial extension of said ring-shaped support member 20 to said axial main extension M of said tooth member 10.

Said engagement portion 14 is configured to be supported by said support portion 12 and project from said support portion 12 so as to engage with said endless track E in said operation position. Said engagement portion 14 is configured project from said support portion 12 away from said support member 20. Said resilient support portion 12 of said tooth member 10 may be denoted support portion 12. Said resilient support portion 12 of said tooth member 10 may be denoted engagement portion support portion 12.

According to an aspect of the present disclosure, when said tooth member 10 is in the operation position, said engagement portion 14 is configured to project from said resilient support member 12 in said main direction essentially parallel to the axial direction of said centre axis Z. According to an aspect of the present disclosure, the length L12, i.e. the distance of the main direction of extension, of the resilient support portion 12 of the tooth member 10 is in the range of 25% to 75%, according to an aspect in the range of 40% to 60% of the length L10 of said tooth member 10. According to an aspect of the present disclosure, the length L14, i.e. the distance of the main direction of extension, of the engagement portion 14 of the tooth member 10 is in the range of 25% to 75%, according to an aspect in the range of 40% to 60% of the length of said tooth member 10. According to an aspect the length L12 of the resilient support portion 12 and the length of the engagement portion 14 corresponds to the length L10 of the toot member 10.

According to the embodiment illustrated in e.g. FIG. 5, said engagement portion 14 is configured to be an integrated portion of said resilient support portion 12. According to an alternative embodiment, not shown, said engagement portion may be configured to be attached to said resilient support portion, i.e. said engagement portion may be a separate part, configured to be attachable to said resilient support portion.

According to an aspect of the present disclosure, as illustrated in e.g. FIG. 5, said resilient support portion 12 of said toot member 10 has a tapering configuration from said ring-shaped support member 20 to said engagement portion 14.

As illustrated in FIG. 5, said support portion 12 has a first width W1 at said support member 20, said first width W1 having an extension essentially orthogonal to said radial direction and orthogonal to the axial direction of the support portion 12. Said first width W1 has an extension essentially corresponding to the circumferential extension of said support member 20. As illustrated in FIG. 5, said support portion 12 has a second width W2 at said engagement portion 14. Said second width W2 has an extension essentially orthogonal to said radial direction and orthogonal to the axial direction of the support portion 12. Said first width W1 is wider than said second width W2 of said support portion 12.

According to an aspect of the present disclosure, said second width W2 is in the range of 15% to 50% of said first width W1, according to an aspect in the range of 20% to 35% of said first width W1. According to an aspect of the present disclosure, said first width W1 is in the range of 15% to 50% of the radial distance R10 to the entire radial distance between the main direction of extension of a tooth member and the centre axis, according to an aspect in the range of 20% to 35% of the radial distance between the main direction of extension of said tooth member and the centre axis.

According to an aspect of the present disclosure, said tooth member 10 has a varying shape along its main extension M, wherein said varying shape comprises varying shape of said support portion 12. Said varying shape of said support portion 12 comprises portions tapering from said ring-shaped support member 20 in its main direction M so as to facilitate high stiffness of the tooth member in the tangential direction of said ring-shaped support member 20 and resilient properties for facilitating deformation of said tooth member 10 in the radial direction if subjected to a radial force F exceeding a certain threshold.

According to an aspect of the drive sprocket member, said support portion 12 of said tooth member 10 has a tapering configuration from said ring-shaped support member 20 towards the engagement portion 14, said tapering configuration having a curvature adapted so as to obtain desired resilient properties and material tensions, such that if said tooth member 10, i.e. the engagement portion 14 of said tooth member 10, is subjected to a radial force exceeding a certain threshold, deformation of said support portion 12 of said tooth member 10 is facilitated. According to an aspect of the drive sprocket member said curvature of said tapering configuration of said support portion 12 of said tooth member 10, has a linear portion and/or an exponential portion and/or a parabolic portion, e.g. according to the elastic curvature of a beam.

According to an aspect of the drive sprocket member, said support portion 12 of said tooth member 10 has a curvature configuration from said ring-shaped support member 20 towards the engagement portion 14 adapted so as to obtain desired resilient properties and material tensions, such that if said tooth member 10 is subjected to a radial force exceeding a certain threshold, deformation of said support portion 12 of said tooth member 10 is facilitated. According to an aspect of the drive sprocket member said curvature configuration of said support portion 12 of said tooth member 10, has a linear portion and/or an exponential portion and/or a parabolic portion.

According to an aspect of the present disclosure, as illustrated in e.g. FIGS. 5 and 7a, said support portion 12 is configured to radially taper in its extension from said ring-shaped support member 20 to said engagement portion 14 so that the radial thickness T-1 of said support portion 12 at said support member 20 is thicker than the radial thickness T-2 at said engagement portion 14.

According to an aspect of the present disclosure, said support portion 12 of said tooth member has a variable radial thickness, wherein said radial thickness is configured to change linearly and/or non-linearly along the main extension of said support portion of said tooth member so as to provide desired resilient properties and so as to provide even material tension.

According to an aspect of the present disclosure, said resilient support portion 12 of said tooth member 10 has an average radial thickness T12, i.e. thickness in the radial direction when arranged in connection to said ring-shaped support member 20 and projecting in a main direction essentially parallel to said centre axis Z, in the range of 5% to 15%, according to an aspect about 7% to 12% of the length of a tooth member. According to an aspect of the present disclosure, the average radial thickness T12 of the support portion 12 of the tooth member 10 essentially corresponds to the axial thickness of said ring-shaped support member 20. According to an aspect of the present disclosure, said support portion 12 of said tooth member 10 is configured to radially taper in its extension from said ring-shaped support member towards said engagement portion 14 with an average angle β in the range of 2 degrees to 15 degrees according to an aspect 4 degrees to 10 degrees. According to an aspect of the present disclosure, said support portion 12 of said tooth member 10 is configured to radially taper in its extension from end of said curved transition TR towards said engagement portion 14 with an average angle β in the range of 2 degrees to 15 degrees preferably 4 degrees to 10 degrees.

According to an aspect of the present disclosure, said curved transition TR from said ring-shaped support portion 20 to said to the support portion 12 of said tooth member 10 is shaped and dimensioned so as to provide contribution of said resilient properties of said support portion 12 of said tooth member 10.

According to an aspect of the drive sprocket member, said resilient support portion 12 of said tooth member 10 has a tapering configuration from said ring-shaped support member 20 to said engagement portion 14, so as to facilitate said resilient properties in the radial direction, such that if said tooth member 10, e.g. said engagement portion 14 of said tooth member, is subjected to a radial force F exceeding a certain threshold, deformation of said tooth member 10 is facilitated.

According to an aspect of the drive sprocket member, said resilient support portion 12 of said tooth member 10 has a tapering configuration from said ring-shaped support member 20 in its main direction so as to facilitate high stiffness of the tooth member 10 in the tangential direction of said ring-shaped support member 20 and resilient properties for deformation of said tooth member 10 in the radial direction.

According to an aspect of the present disclosure, as illustrated in e.g. FIG. 5 said support portion 12 has a radial outer side 12a facing away from said centre axis Z, an opposite radial inner side 12b.

According to an aspect of the present disclosure, as illustrated in e.g. FIG. 5 said support portion 12 further has a first long side 12e and an opposite second long side 12f, said long sides 12e, 12f running from said ring-shaped support member 20 to said engagement portion 14.

According to an aspect of the present disclosure, as illustrated in e.g. FIG. 5 said first and second long sides 12e, 12f have an S-shaped configuration in a plane essentially orthogonal to the axial and radial extension of said support portion so as to form said tapering shape. According to an aspect of the present disclosure, said support portion 12 may be said to have a funnel like configuration.

According to an aspect of the present disclosure, as illustrated in e.g. FIGS. 5 and 7a-b, said support portion 12 has a first portion 12-1 arranged at said ring-shaped support member 20. Said first portion 12-1 is configured to radially extend from a radial outer portion 20a of said support member 20. Said first portion 12-1 is further configured to extend along the outer circumference of said support member 20 so as to provide stiffness of said toot member 10 in the tangential direction of said support member 20. According to an aspect of the present disclosure, said first portion 12-1 is further configured to extend along the outer circumference of said support member 20 with an arc-shaped extension essentially following and hence corresponding to the arc-shaped extension of said ring-shaped support member 20.

According to an aspect of the present disclosure, as illustrated in e.g. FIGS. 5 and 7a-b, said support portion 12 has a second portion 12-2 arranged at said engagement portion 14. Said second portion 12-2 is arranged to provide a transition to said engagement portion 14.

According to an aspect of the present disclosure, as illustrated in e.g. FIGS. 5 and 7a-b, said second portion 12-2 of said support portion 12 is configured to provide said transition to said engagement portion 14 so that, when said tooth member 10 is in the operation position, a radial outer side 14a of said engagement portion 14 is radially further away from said centre axis Z than a radial outer side 12a of said support portion 12. Said radial outer side 14a of said engagement portion 14 is a portion of the radial outer side 10a of said tooth member 10.

According to an aspect of the present disclosure, as illustrated in FIG. 7a, said second portion 12-2 of said support portion 12 has a curved cross section so as to provide said level change of said radial outer side 10a of said tooth member from said radial outer side 12a of said support portion 12 to said radial outer side 14a of said engagement portion 14 so that the radial outer side 14a is radially further away from said centre axis than said radial outer side 12a. According to an aspect of the present disclosure, as illustrated in FIG. 7a, said second portion 12-2 of said support portion is shaped so as to provide resilient properties so as to facilitate said deformation of said tooth member 10.

According to an aspect of the present disclosure, as illustrated in e.g. FIG. 5, said support portion 12 support portion 12 further comprises an intermediate portion 12-3 arranged between said first portion 12-1 and second portion 12-2. Said intermediate 12-3 portion is configured, in the operation position of said tooth member 10, to extend in the main direction of the tooth member, i.e. in an axial direction essentially parallel to the extension of said centre axis. In said operation position of said tooth member 10, said intermediate portion 12-3 is configured to taper in its extension from said ring-shaped support member 20 to said engagement portion 14 in a plane essentially orthogonal to the axial and radial extension. According to an aspect of the present disclosure, said intermediate 12-3 portion is configured, in the operation position of said tooth member 10, to extend in the main direction M of the tooth member from said first portion 12-1, as an extension of said first portion 12-1, to said second portion 12-2, said second portion 12-2 being an extension of said intermediate portion 12-3.

As illustrated in e.g. FIGS. 2, 5 and 7a-b said engagement portion 14 has a radial outer side 14a which, when said tooth member 10 is in the operation position, in connection to engagement with said endless track E is configured to face a radial inner side of E4 of said endless track E, see FIG. 2.

As illustrated in e.g. FIG. 5 said engagement portion 14 has a transversal end side 14c furthest away from said support member 12 and an opposite end side 14d in connection to the transition to said support portion 12.

According to an aspect of the present disclosure, said engagement portion 14 has an U-shaped configuration, illustrated in e.g. FIG. 5. According to an aspect of the present disclosure, illustrated in FIG. 5, said engagement portion 14 has a first wall portion 14-1 and a second wall portion 14-2 running along each other at a distance from each other and configured to extend in the axial main extension of said tooth member 10, and a bottom portion 14-3 from which said wall portions 14-1, 14-2 are configured to protrude. The protrusion of said wall portion 14-1, 14-2 from said bottom portion 14-3 is according to an aspect in a slight outward direction compared to the orthogonal direction so that the opposite wall portions 14-1, 14-2 extend away from each other from said bottom portion 14-3 to their respective ends. Said U-shaped engagement portion 14 is configured to engage between inner protrusions of said endless track E, said inner side E4 according to an aspect being between said protrusions, see FIG. 2.

According to an aspect of the present disclosure, said engagement portion 14 has a radial inner side 14b configured to face inwardly towards said centre axis Z. According to an aspect of the present disclosure, said first wall portion 14-1 has a radial end portion 14-2b and said second wall portion 14-2 has a radial end portion 14-2b, said radial end portions 14-1b, 14-2b being configured to face inwardly, essentially opposite to said radial outer side 14a of said engagement portion 14. According to the embodiment with the U-shaped engagement portion 14, said radial end portions 14-1b, 14-2b correspond to the radial inner side 14b.

According to an aspect of the present disclosure, said engagement portion 14 has a first outer side 14e facing in a direction essentially orthogonal to the axial and radial extension of said engagement portion 14 and an opposite second outer side 14f. Said first outer side 14e is the outer side of said first wall portion 14-1 and said second outer side 14f is the outer side of said second wall portion 14-2.

Said bottom portion 14-3 of said U-shaped engagement portion 14 has a radial outer side 14-3a facing away from said centre axis Z. According to the embodiment with the U-shaped engagement portion 14, said radial outer side 14-3a of said bottom portion 14-3 corresponds to the radial outer side 14a of said engagement portion 14. Said bottom portion 14-3 of said U-shaped engagement portion 14 has a radial inner side 14-3b essentially opposite to said radial outer side 14-3a.

According to an aspect of the present disclosure, schematically illustrated in FIG. 5, said drive sprocket member S1 may further comprise one or more sheet metal elements 30 configured to be arranged internally around said drive sprocket member S1 in connection to at least parts of the transversal end side 20c of said support member 20 from which said tooth member 10 is projecting and at least parts of the radial inner side 10b of said tooth member 10. Said one or more sheet metal elements 30 are configured to be arranged so as to increase the spring force of said tooth members 10. Such one or more sheet metal elements 30 are according to an aspect separate element(s) 30 configured to be mounted in connection to said transversal end side 20c of said support member 20 and radial inner side 10b of said tooth members 10. According to an aspect of the present disclosure, said mounting of said one or more sheet metal elements 30 may be provided with pre-tension. According to an aspect of the present disclosure, said mounting of said one or more sheet metal elements 30 may be provided without pre-tension.

Said one or more sheet metal elements 30 may be assembled to said transversal end side 20c of said support member 20 and radial inner side 10b of said tooth members 10 in any suitable way, e.g. by means of joint members and/or folding of said sheet metal element 30 in connection to tooth members 10 and/or said support member 20.

FIG. 7a schematically illustrates a cross sectional side view of a tooth member 10, where said tooth member is in the operation position, projecting from the transversal first end side 20c of the ring-shaped support member 20 in a main direction essentially parallel to the axial direction of said centre axis, not shown in FIG. 7a. FIG. 7b schematically illustrates a cross sectional side view of the tooth member, where the tooth member 10 has been subjected to a radial force F causing a deformation of the tooth member 10.

Said tooth member 10, illustrated in FIGS. 7a-b, is arranged in connection to said ring-shaped support member 20 and shaped so as to provide resilient properties in the radial direction such that, when said tooth member 10, as illustrated in FIG. 7b, is subjected to an inwardly directed radial force F exceeding a certain threshold, said tooth member 10 is configured to deform relative to its operation position.

According to an aspect of the present disclosure, a thus arranged and configured tooth member 10, subjected to a radial force, may be configured to deform so that said tooth member 10 projects from the ring-shaped support member 20 in a main direction M1 with an angle relative to and towards the axial direction of said centre axis Z up to at least 20 degrees, according to an aspect up to at least 30 degrees, according to an aspect up to at least 40 degrees, according to an aspect up to at least 50 degrees, according to an aspect up to at least 60 degrees, according to an aspect up to at least 70 degrees, according to an aspect up to at least 80 degrees. Said angle up to which said tooth member 10 is allowed to deform may depend on said arrangement and configuration of said tooth member comprising radial, axial and tangential extension, but also the modulus of elasticity of said tooth member, and where applicable the modulus of elasticity of said ring-shaped support member 20 in connection to said tooth member. When said tooth member 10 is thus deformed, said tooth member is retained in connection to said ring-shaped support member.

According to an aspect, said tooth member 10 in FIG. 7b is subjected to an inwardly directed radial force F1 exceeding a first threshold and up to second threshold, so that said tooth member 10 elastically deforms relative to its operation position illustrated in FIG. 7a so that, when said tooth member 10 is no longer subjected to said radial force F1, said tooth member 10 will to return from its deformed position in FIG. 7b to its operation position in FIG. 7a.

Said deformation illustrated in FIG. 7b corresponds to said tooth member 10 projecting from the ring-shaped support member 20 in a main direction with an angle a relative to and towards the axial direction of said centre axis, not shown in FIG. 7b. Said deformation illustrated in FIG. 7b corresponds to said tooth member 10 projecting from the ring-shaped support member 20 in a main direction M1 with an angle a inwardly relative to its main extension, i.e. essentially axial or transversal extension illustrated in FIG. 7a. Said deformation illustrated in FIG. 7b corresponds to said tooth member 10 moving from said operation position in a direction D so that it is projecting from the ring-shaped support member 20 in a main direction with an angle a inwardly relative to its main extension, i.e. essentially axial or transversal extension, illustrated in FIG. 7a. Said angle a depends among other of the inward radial force F acting on said tooth member 10. According to an aspect said force F1 corresponds to the force up to which said tooth member 10 would elastically deform.

According to an aspect of the present disclosure, said radial force F1 up to which said tooth member 10 would elastically deform, may depend on said arrangement and configuration of said tooth member comprising radial, axial and tangential extension, but also the modulus of elasticity of said tooth member. According to an aspect of the present disclosure, for a tracked vehicle such as a combat vehicle, said radial force F1 up to which said tooth member 10 would elastically deform may be in the range of 40 kN to 140 kN, according to an aspect in the range of 70 kN to 120 kN. According to an aspect, said tooth member 10 may be configured to elastically deform when subjected to any radial force up to such exemplified forces, however, in order to obtain an elastic deformation that would result in any clearly visible radial movement of said tooth member 10, a radial force exceeding a certain value would be required.

According to an aspect of the present disclosure, during standstill and normal operation of a tracked vehicle such as a combat vehicle, when there is no particular force on a single tooth member (or a pair of tooth members or so) due to e.g. stone or gravel between tooth member and endless track, there will be essentially no or very little radial elastic deformation of the distributed set of tooth members of the drive wheel member of the track assembly of the tracked vehicle, since the weight of the tracked vehicle is distributed over a large surface, and the fact that the drive wheel member, at least during standstill, normally does not have any contact with the ground. During drive of such a tracked vehicle, the tangential drive force transferred from the tooth members to the endless track is distributed over a large number of tooth members.

According to an aspect of the present disclosure, a thus arranged and configured tooth member 10, subjected to such a radial force F1, may be configured to elastically deform so that said tooth member 10 projects from the ring-shaped support member 20 in a main direction M1 with an angle relative to and towards the axial direction of said centre axis Z in the range of 10 degrees to 50 degrees, according to an aspect in the range of 15 degrees to 35 degrees.

According to an aspect, if said tooth member 10 in FIG. 7b would be subjected to an inwardly directed radial force F2 exceeding said second threshold up to which said tooth member 10 is subjected to said elastic deformation, e.g. exceeding said force F1, said tooth member 10 would plastically deform relative to its operation position so that, when said tooth member 10 is no longer subjected to said radial force F2, said tooth member 10 would essentially remain in its deformed position and be retained to said support member.

Such a plastically deformed tooth member 10 may then be repaired by proper tools facilitating returning said plastically deformed tooth member to its operation position. According to an aspect of the present disclosure, if said deformed tooth member 10 in FIG. 7b illustrates an elastically deformed tooth member 10, the angle of the tooth member 10, should it be subjected to a higher force F2, would be greater than the angle a illustrated in FIG. 7b.

During operation, i.e. drive of the tracked vehicle V according to the present disclosure, ingestion of objects in the shape of undesired material such as gravel and stones into the respective track assembly and in between tooth members 10 of drive sprocket members of drive wheel members DW1, DW2, and the endless track E may occur.

According to the present disclosure, tooth members 10 of said set of tooth members 10, have said radial outer side 10a which, when a tooth member 10 is in the operation position, in connection to engagement with said endless track E is configured to face a radial inner side of E4 of said endless track E. The respective tooth member 10 of said set of tooth members 10 is configured such that if one or more objects such as gravel, stones or the like, during operation of said tracked vehicle V is ingested between said radial inner side E4 of said endless track E and said radial outer side 14a of said tooth member 10 so that said tooth member 10 is subjected to an inward radial force F exceeding a certain threshold, said tooth member 10 is configured to deform relative to its operation position so that said one or more objects are allowed to escape.

If said tooth member 10 is subjected to a an inward radial force F1 exceeding a first threshold and up to second threshold, said tooth member 10 is configured to elastically deform relative to its operation position so that said object is allowed to escape, and if said tooth member 10 is subjected to an inward radial force F2 exceeding said second threshold said tooth member 10 is configured to plastically deform relative to its operation position so that said object is allowed to escape. Said drive sprocket member S1, and in particular the arrangement of said tooth members 10 in connection to said ring-shaped support member 20 and the resilient properties of said tooth members 10, facilitate retention of said tooth members when subjected to such radial forces.

According to an aspect of the present disclosure, the angle/angles relative to its operation position to which said tooth member 10 may deform is/are set to desired angle/angles based resilient properties due to arrangement and shape of said tooth member 10 for facilitating escape of such objects.

More particularly, the respective tooth member 10 of said set of tooth members 10 is configured such that if one or more objects such as gravel and or stones, during operation of said tracked vehicle V, are introduced between said radial inner side E4 of said endless track E and said radial outer side 14a of said engagement portion 14 of said tooth member 10 so that said tooth member 10 is subjected to a radial force F, in the direction towards said centre axis Z, exceeding a certain threshold, said tooth member 10 is configured to deform relative to its operation position so that said at least one object is allowed to escape.

In FIG. 7b, a portion of the radial inner side E4 of said endless track is illustrated. According to an aspect of the present disclosure, said tooth member 10 is configured and arranged in connection to said ring-shaped support member 20 and shaped so as to provide resilient properties in the radial direction such that if one or more objects, in FIG. 7b schematically illustrated with an object O, during operation of said tracked vehicle is introduced between said radial inner side E4 of said endless track E and said radial outer side 10a of said tooth member 10 so that said tooth member 10 is subjected to a radial force F, in the direction towards said centre axis, exceeding a certain threshold, said tooth member 10 is configured to deform relative to its operation position so that said one or more objects O are subjected to an axial force F3 in an outward transversal direction so that said one or more objects O escape from the track assembly and hence tracked vehicle. The axial force F3 is directed in the transversal direction away from said ring shaped support member 20. The dotted line in connection to the radial upper side of said object O illustrates a portion of the tooth member 10 at an earlier position of said transformation in the direction D.

Thus, as illustrated in FIG. 7b, said tooth member 10 is, according to an aspect, configured and arranged in connection to said ring-shaped support member 20 and shaped so as to provide resilient properties in the radial direction such that if one or more objects O, during operation of said tracked vehicle is introduced between said radial inner side E4 of said endless track and said radial outer side 10a of said tooth member 10 so that said tooth member 10 is subjected to a radial force F, in the direction towards said centre axis, exceeding a certain threshold, said tooth member 10 is configured to deform relative to its operation position so that said tooth member 10 is projecting from the ring-shaped support member in a main direction with an angle a relative to and towards the axial direction of said centre axis, so that said one or more objects, due to the shape and resilient properties and the angled deformation of said tooth member 10 relative to the radial inner side E4 of said endless track E, are subjected to an axial force F3 in an outward transversal direction so that said one or more objects O are configured to escape from the track assembly to which said drive sprocket member is connected, and hence escaped from the tracked vehicle so that damage to the endless track E and any permanent damage to the drive sprocket member may be efficiently avoided.

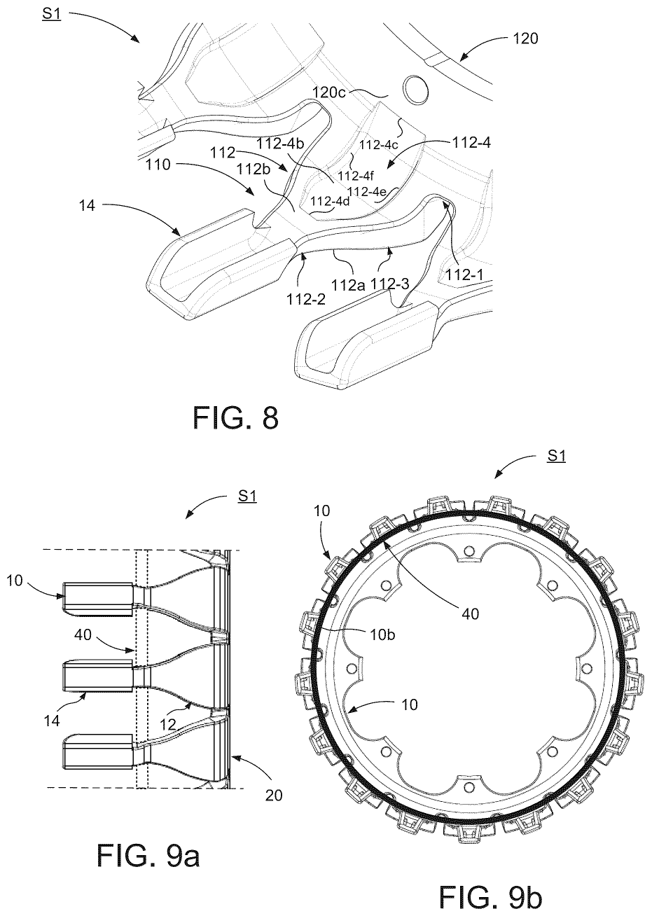

FIG. 8 schematically illustrates a perspective view of a portion of a drive sprocket member S1, focusing on a tooth member 110, according to an embodiment of the present disclosure.

Said drive sprocket member S1 in FIG. 8 has a tooth member 110 essentially corresponding to the tooth member 10 in e.g. FIGS. 4 and 5, and only differs from the tooth member 10 in e.g. FIGS. 4 and 5 by part of the configuration of the support portion 112 of the tooth member 110 and part of the support member 120 in connection to said support portion 112.

As the tooth member 10, the tooth member 110 comprises a support portion 112 and an engagement portion 14 arranged, in the operation position, with essentially the same main extension from said support member 120, where said support portion 112 is configured to radially taper in its extension from said ring-shaped support member 120 both with regard to width and thickness.

According to an aspect of the present disclosure, said support portion 112 has a radial outer side 112a essentially corresponding to the radial outer side 12a of said support portion 12.

According to an aspect of the present disclosure, as illustrated in FIG. 8, said support portion 112 has a first portion 112-1 arranged at said ring-shaped support member 120, extending from a radial outer portion of said support member 120, and extending along the outer circumference of said support member 120 so as to provide stiffness of said toot member 110 in the tangential direction of said support member 120. Said support portion 112 has a second portion 112-2 arranged at said engagement portion 14. Said second portion 112-2 is arranged to provide a transition to said engagement portion 14.

According to an aspect of the present disclosure, as illustrated in e.g. FIG. 8, said support portion 112 further comprises an intermediate portion 112-3 arranged between said first portion 112-1 and second portion 112-2. Said intermediate 112-3 portion is configured, in the operation position of said tooth member 110, to extend in the main direction of the tooth member 110, i.e. in an axial direction essentially parallel to the extension of said centre axis. In said operation position of said tooth member 110, said intermediate portion 112-3 is configured to taper in its extension from said ring-shaped support member 120 to said engagement portion 14 in a plane essentially orthogonal to the axial and radial extension.

The drive sprocket member S1 schematically illustrated in FIG. 8 differs from the drive sprocket member illustrated e.g. in FIGS. 4 and 5, in that said tooth member 110 comprises a topographic geometric configuration 112-4 arranged in connection to the transition from said support member 120 to said resilient support portion 112 so as to even out stiffness differences and optimize elastic properties of said tooth member 110. According to an aspect of the present disclosure, said topographic geometric configuration 112-4 is configured to be provided by means of a relatively shallow recess 112-4 running from an essentially transversal end side 120c of said support member 120 centrally into the radial inner side 112b of said support portion 112 of said tooth member 110. According to an aspect of the present disclosure, said recess 112-4 has a first end side 120c at said support member 120, an opposite second end side 112-4d at said transition to said engagement portion 14. According to an aspect of the present disclosure, said recess 112-4 further comprises opposite inner long sides 112-4e, 112-4f at least partly following the outer long sides of said support portion 112, and a bottom portion with a bottom side 112-4b surrounded by said first and second end sides 112-4c, 112-4d and opposite long sides 112-4e, 112-4f.

FIG. 9a schematically illustrates a side view of a portion of a drive sprocket member S1 according to an embodiment of the present disclosure; and, FIG. 9b schematically illustrates a front view of the drive sprocket member S1 in FIG. 9a, according to an embodiment of the present disclosure.

The drive sprocket member S1 illustrated in FIGS. 9a-b essentially corresponds to the drive sprocket member in e.g. FIGS. 3 and 6. The drive sprocket member S1 illustrated in FIGS. 9a-b further comprises a support ring 40 configured to be arranged around said set of tooth members 10 in connection to the radial inner side 10b of said tooth members 10 at the transition from said support portion 12 to said engagement portion 14 so as to increase the radial stiffness of said set of tooth members 10.

According to an aspect of the present disclosure, said support ring 40 may have resilient properties so as to deform when subjected to a radial force in the direction towards said centre axis. According to an aspect of the present disclosure, said support ring 40 may have resilient properties so as to elastically deform when subjected to a radial force in the direction towards said centre axis. According to an aspect of the present disclosure, said support ring 40 may have resilient properties so as to plastically deform when subjected to a radial force in the direction towards said centre axis exceeding a predetermined threshold. According to an aspect of the present disclosure, said support ring 40 may be of the same material as said tooth members 10. According to an aspect of the present disclosure, said support ring 40 may be a separate part of said sprocket member, thus attachable in connection to the radial inner side of said tooth members 10 at the transition from said support portion to said engagement portion.

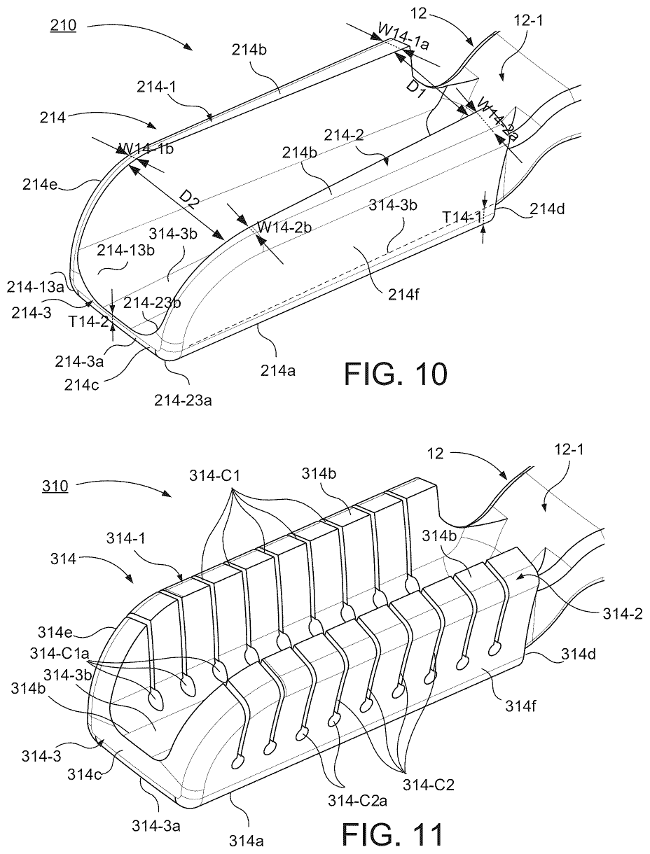

FIG. 10 schematically illustrates a perspective view of an engagement portion 214 of a tooth member 210, according to an embodiment of the present disclosure.

Said tooth member 210 in FIG. 10 essentially differs from tooth member 10 in e.g. FIG. 5 with regard to said engagement portion 214.

Said engagement portion 214 has a radial outer side 214a which, when said tooth member 10 is in the operation position, in connection to engagement with said endless track E is configured to face a radial inner side of E4 of said endless track E.

As illustrated in e.g. FIG. 10 said engagement portion 214 has a transversal end side 214c furthest away from said support member 12 and an opposite end side 214d in connection to the transition to said support portion 12.

Said engagement portion 214 has, as the engagement portion 14 described above with reference to e.g. FIG. 5, an U-shaped configuration. According to an aspect of the present disclosure, illustrated in FIG. 10, said engagement portion 214 has a first wall portion 214-1 and a second wall portion 214-2, said wall portions 214-1, 214-2 being configured to extend in the axial main extension of said toot member 210, and a bottom portion 214-3 from which said wall portions 214-1, 214-2 are configured to protrude.

According to an aspect of the present disclosure, said engagement portion 214 has a radial inner end side 214b configured to face inwardly towards said centre axis Z.

According to an aspect of the present disclosure, said engagement portion 214 has a first outer side 214e facing in a direction essentially orthogonal to the axial and radial extension of said engagement portion 214 and an opposite second outer side 214f. Said first outer side 214e is the outer side of said first wall portion 214-1 and said second outer side 214f is the outer side of said second wall portion 214-2. The transition from the end side 214b of the respective wall portion 214-1, 214-2 to their respective outer side 214e, 214f may be curved, e.g. an essentially arc-shaped transition.

Said bottom portion 214-3 of said U-shaped engagement portion 214 has a radial outer side 214-3a facing away from said centre axis Z. According to the embodiment with the U-shaped engagement portion 214, said radial outer side 214-3a of said bottom portion 214-3 corresponds to the radial outer side 214a of said engagement portion 214. Said bottom portion 214-3 of said U-shaped engagement portion 214 has a radial inner side 214-3b essentially opposite to said radial outer side 214-3a.

According to the embodiment of the tooth member 214 illustrated in FIG. 10, the inner surface of said U-shaped engagement portion 214 is formed such that there is a variation of the thickness of the U-shaped engagement portion 214, so as to increase the elastic properties of said engagement portion 214.

According to an aspect of the present disclosure the formation of the inner surface of said U-shaped engagement portion 214 is such that the respective wall portion 214-1, 214-2 is configured to taper from the transition from the support portion 12 along its main extension towards its end side 214c.

As illustrated in FIG. 10, said first wall portion 214-1 has a first width W14-1a at the transition from said support portion 12, said first width W14-1a having an extension essentially orthogonal to said radial direction and orthogonal to the axial direction of the engagement portion 14. As illustrated in FIG. 10, said first wall portion 214-1 has a second width W14-1b close to the transversal end side 214c, said second width W14-1b having an extension essentially orthogonal to said radial direction and orthogonal to the axial direction of the engagement portion 214. Said first width W14-1a is wider than said second width W14-1b of said first wall portion 214-1.

As illustrated in FIG. 10, said second wall portion 214-2 has a first width W14-2a at the transition from said support portion 12, said first width W14-2a having an extension essentially orthogonal to said radial direction and orthogonal to the axial direction of the engagement portion 14. As illustrated in FIG. 10, said second wall portion 214-2 has a second width W14-2b close to the transversal end side 214c, said second width W14-2b having an extension essentially orthogonal to said radial direction and orthogonal to the axial direction of the engagement portion 14. Said first width W14-2a is wider than said second width W14-2b of said second wall portion 214-2.

Said first wall portion 214-1 and second wall portion 214-2 have a main extension and are tapering such that the distance D1 between the inner sides of said wall portions 214-1, 214-2 facing each other at the end side 214d is shorter than the distance between the inner sides of said wall portions 214-1, 214-2 close to the transversal end side 214c.

According to an aspect of the present disclosure the formation of the inner surface of said U-shaped engagement portion 214 is such that the bottom portion 214-3 is configured to taper from the said transition from the support portion 12 along its main extension towards its transversal end side 214c.

Said first wall portion 214-1 has an outer transition 214-13a from its outer side 214e to the radial outer side 214a of said bottom portion 214-3, and an opposite inner transition 214-13b from its inner side to the radial inner side 214b of said bottom portion 214-3. Said second wall portion 214-2 has an outer transition 214-23a from its outer side 214f to the radial outer side 214a of said bottom portion 214-3, and an opposite inner transition 214-23b from its inner side to the radial inner side 214b of said bottom portion 214-3. According to an aspect of the present disclosure the formation of the inner surface of said U-shaped engagement portion 214 is such that the inner transition 214-13b, 214-23b from the respective wall portion 214-1, 214-2 to inner side 214b of the bottom portion 214-3 has an arc-shaped or angled form so that the thickness T14-1 in connection to said transitions is greater than the thickness T14-2 of the central portion of the bottom portion 214-3.

FIG. 11 schematically illustrates a perspective view of an engagement portion 314 of a tooth member 310, according to an embodiment of the present disclosure.

Said tooth member 310 in FIG. 10 essentially differs from tooth member 10 in e.g. FIG. 5 with regard to said engagement portion 314.

Said engagement portion 314 has a radial outer side 314a which, when said tooth member 10 is in the operation position, in connection to engagement with said endless track E is configured to face a radial inner side of E4 of said endless track E.

As illustrated in e.g. FIG. 11 said engagement portion 314 has a transversal end side 314c furthest away from said support portion 12 and an opposite end side 314d in connection to the transition to said support portion 12.

Said engagement portion 314 has, as the engagement portion 14, an U-shaped configuration. According to an aspect of the present disclosure, illustrated in FIG. 11, said engagement portion 314 has a first wall portion 314-1 and a second wall portion 314-2, said wall portions 314-1, 314-2 being configured to extend in the axial main extension of said toot member 310, and a bottom portion 314-3 from which said wall portions 314-1, 314-2 are configured to protrude.

According to an aspect of the present disclosure, said engagement portion 314 has a radial inner end side 314b configured to face inwardly towards said centre axis Z.

According to an aspect of the present disclosure, said engagement portion 314 has a first outer side 314e facing in a direction essentially orthogonal to the axial and radial extension of said engagement portion 314 and an opposite second outer side 314f. Said first outer side 314e is the outer side of said first wall portion 314-1 and said second outer side 314f is the outer side of said second wall portion 314-2. The transition from the end side 314b of the respective wall portion 314-1, 314-2 to their respective outer side 314e, 314f may be curved, e.g. an essentially arc-shaped transition.

Said bottom portion 314-3 of said U-shaped engagement portion 314 has a radial outer side 314-3a facing away from said centre axis Z. According to the embodiment with the U-shaped engagement portion 314, said radial outer side 314-3a of said bottom portion 314-3 corresponds to the radial outer side 314a of said engagement portion 314. Said bottom portion 314-3 of said U-shaped engagement portion 314 has a radial inner side 314-3b essentially opposite to said radial outer side 314-3a.

According to the embodiment of the tooth member 314 illustrated in FIG. 11, the respective wall portion 314-1, 314-2 of said U-shaped engagement portion 314 is shredded with thin cuts 314-C1, 314C2 from its radial end side 314b towards the bottom portion 314-3 in a plane orthogonal to its longitudinal extension, so as to locally reduce the stiffness of said engagement portion 314.

According to an aspect said shredded cuts 314-C1, 314C2 of the respective wall portion 314-1, 314-2 ends with a through opening 314C1a, 314C2a wider than said cuts and configured to run from the lower outer side 314e, 314f of the respective wall portion 314-1, 314-2 to their respective inner side or to the transition from their respective inner side to inner side 314-3b of said bottom portion 314-3.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications suited to the particular use contemplated.

1. A drive sprocket member for a drive wheel member for an endless track of a tracked vehicle, the drive wheel member being rotatable about a centre axis for rotating said endless track, said drive wheel member comprising said drive sprocket member, said drive sprocket member comprising a set of tooth members arranged around the circumference of said drive sprocket member, and a ring-shaped support member for said tooth members, said tooth members being configured to project from the ring-shaped support member in a main direction essentially parallel to the axial direction of said centre axis so that said tooth members are in an operation position for engaging with said endless track for facilitating said rotation of said endless track, wherein said tooth members are arranged in connection to said ring-shaped support member and shaped so as to provide resilient properties in the radial direction such that, if a tooth member of said set of tooth members is subjected to a radial force, in the direction towards said centre axis, exceeding a certain threshold, deformation of said tooth member relative to its operation position is facilitated.

2. The drive sprocket member of claim 1, wherein said tooth members comprise a material having a predetermined modulus of elasticity, wherein said shape of said tooth members, comprising radial, axial and tangential extension and configuration, in combination with said predetermined modulus of elasticity of the material of said tooth members, provides said resilient properties, so that, if a tooth member is subjected to said radial force, deformation of said tooth member in the direction towards said centre axis is facilitated.

3. The drive sprocket member of claim 1, wherein the respective tooth member has a varying shape along its main extension, said varying shape comprising portions tapering from said ring-shaped support member in its main direction so as to facilitate high stiffness of the respective tooth member in the tangential direction of said ring-shaped support member and resilient properties for facilitating deformation of a tooth member in the radial direction if subjected to a radial force exceeding said certain threshold.

4. The drive sprocket member of claim 1, wherein said tooth members are arranged in connection to said ring-shaped support member and shaped so as to provide resilient properties in the radial direction such that, if a tooth member of said set of tooth members is subjected to a radial force, in the direction towards said centre axis, exceeding a first threshold and up to a second threshold, said tooth member is configured to elastically deform relative to its operation position so that, when said tooth member is no longer subjected to said radial force, said tooth member is configured to return to its operation position.

5. The drive sprocket member of claim 1, wherein said tooth members are arranged in connection to said ring-shaped support member and shaped so as to provide resilient properties in the radial direction such that, if a tooth member of said set of tooth members is subjected to a radial force, in the direction towards said centre axis, exceeding a second threshold, said tooth member is configured to plastically deform relative to its operation position so that, when said tooth member is no longer subjected to said radial force, said tooth member is configured to essentially remain in its deformed position.

6. The drive sprocket member of claim 1, wherein said tooth members are arranged in connection to said ring-shaped support member and shaped so as to provide resilient properties in the radial direction such that, if a tooth member of said set of tooth members is subjected to a radial force, in the direction towards said centre axis, so that said tooth member deforms relative to its operation position, said deformation will correspond to said tooth member projecting from the ring-shaped support member in a main direction with an angle relative to and towards the axial direction of said centre axis.

7. The drive sprocket member of claim 1, wherein said tooth member has a radial outer side which, when said tooth member is in the operation position, in connection to engagement with said endless track is configured to face a radial inner side of said endless track, wherein said tooth member is configured such that if one or more objects, during operation of said tracked vehicle is introduced between said radial inner side of said endless track and said radial outer side of said tooth member so that said tooth member is subjected to a radial force, in the direction towards said centre axis, exceeding a certain threshold, said tooth member is configured to deform relative to its operation position so that said one or more objects are allowed to escape.

8. The drive sprocket member of claim 1, wherein at least one tooth member of said set of tooth members, comprises a resilient support portion having said resilient properties, and an engagement portion for engagement with said endless track, wherein said resilient support portion is configured to be arranged in connection to said ring-shaped support member and, in the operation position of said tooth member, project from said ring-shaped support member in said main direction essentially parallel to the axial direction of said centre axis, and wherein said engagement portion is configured to be supported by said support portion and project from said support portion so as to engage with said endless track in said operation position.

9. The drive sprocket member of claim 8, wherein said support portion of said toot member has a tapering configuration from said ring-shaped support member to said engagement portion, where said support portion has a first width at said support member extending essentially orthogonal to said radial direction and its axial direction, and a correspondingly extending second width at said engagement portion, said first width being wider than said second width of said support portion.

10. The drive sprocket member of claim 8, wherein said support portion is configured to radially taper in its extension from said ring-shaped support member to said engagement portion so that the radial thickness of said support portion at said support member is thicker than the radial thickness at said engagement portion.

11. The drive sprocket member of claim 9, wherein said support portion has a radial outer side away from said centre axis, an opposite radial inner side, a first long side and an opposite second long side, said long sides running from said ring-shaped support member to said engagement portion, wherein said first and second long sides have an S-shaped configuration in a plane essentially orthogonal to its axial and radial extension so as to form said tapering shape.

12. The drive sprocket member of claim 8, wherein said support portion has a first portion arranged at said ring-shaped support member, said first portion being configured to radially extend from a radial outer portion of said ring-shaped support member and extend along the outer circumference of said support member so as to provide stiffness of said toot member in the tangential direction of said support member.

13. The drive sprocket member of claim 12, wherein said support portion has a second portion arranged at and providing a transition to said engagement portion, said support portion further comprising an intermediate portion arranged between said first portion and second portion, wherein, in said operation position of said tooth member, said intermediate portion is configured to taper in its extension from said ring-shaped support member to said engagement portion in a plane essentially orthogonal to the axial and radial extension.

14. The drive sprocket member of claim 8, wherein said tooth member comprises a topographic geometric configuration arranged in connection to the transition from said support member to said resilient support portion so as to even out stiffness differences and/or optimize elastic properties of said tooth member, said topographic geometric configuration being configured to be provided by means of a relatively shallow recess running from an essentially transversal end side of said support member centrally into the radial inner side of said support portion of said tooth member.

15. The drive sprocket member of claim 14, wherein said second portion of said support portion is configured to provide said transition to said engagement portion so that, when said tooth member is in the operation position, a radial outer side of said engagement portion is radially further away from said centre axis than a radial outer side of said support portion.

16. The drive sprocket member of claim 8, wherein said engagement portion has a radial outer side which, when said tooth member is in the operation position, in connection to engagement with said endless track is configured to face a radial inner side of said endless track, wherein said tooth member is configured such that if one or more objects, during operation of said tracked vehicle, are introduced between said radial inner side of said endless track and said radial outer side of said engagement portion so that said tooth member is subjected to a radial force, in the direction towards said centre axis, exceeding a certain threshold, said tooth member is configured to deform relative to its operation position so that said at least one object is allowed to escape.

17. The drive sprocket member of claim 8, wherein said engagement portion has an U-shaped configuration, said engagement portion having wall portions configured to extend in the axial main extension of said toot member, and a bottom portion from which said wall portions are configured to protrude, said bottom portion having a radial outer side facing away from said centre axis.

18. The drive sprocket member of claim 17, wherein the inner surface of said engagement portion, having a U-shaped configuration, is formed such that there is a variation of the thickness of the U-shaped engagement portion, so as to increase the elastic properties of said engagement portion.

19. The drive sprocket member of claim 17, wherein said wall portions of said U-shaped engagement portion are shredded with thin cuts from its radial end side towards the bottom portion in a plane orthogonal to its longitudinal extension, so as to locally reduce the stiffness of said engagement portion.

20. The drive sprocket member of claim 1, wherein one or more tooth members of said set of tooth members are configured to be an integrated portion of said ring-shaped support member.

21. The drive sprocket member of claim 8, wherein said resilient support portion is configured to be an integrated portion of said ring-shaped support member.

22. The drive sprocket member of claim 8, wherein said engagement portion is configured to be an integrated portion of said resilient support portion.

23. The drive sprocket member of claim 8, wherein said engagement portion is configured to be attached to said resilient support portion.

24. The drive sprocket member of claim 1, further comprising one or more sheet metal elements configured to be arranged internally around said drive sprocket member in connection to at least parts of a transversal end side of said support member from which said tooth member is projecting and at least parts of a radial inner side of said tooth member, said one or more sheet metal elements being arranged so as to increase the spring force.

25. The drive sprocket member of claim 8, further comprising a support ring configured to be arranged around said set of tooth members in connection to the radial inner side of said tooth members at the transition from said support portion to said engagement portion so as to increase the radial stiffness of said set of tooth members.

26. A drive wheel member comprising at least one drive sprocket member of claim 1.

27. The drive wheel member of claim 26, wherein said drive wheel member comprises a hub member for facilitating said rotation of said drive wheel member, wherein said drive wheel member comprises a transversal outer drive sprocket member arranged in connection to a transversal outer side of the hub member and a transversal inner drive sprocket member arranged in connection to a transversal inner side of the hub member, the transversal outer side facing out from a vehicle in the transversal direction of the tracked vehicle and the transversal inner side facing in the opposite transversal direction of the tracked vehicle to which the drive wheel member is mounted.

28. A tracked vehicle comprising a drive sprocket member of claim 1.
